(19) United States
(12) Patent Application Publication
(10) Pub. No.: US 2025/0141002 A1
(43) Pub. Date: May 1, 2025

(54) ELECTROCHEMICAL CELL SYSTEMS WITH DIVERGENT CELL CHEMISTRIES AND METHODS OF PRODUCING THE SAME

(71) Applicant: 24M Technologies, Inc., Cambridge, MA (US)

(72) Inventors: Junhua SONG, Watertown, MA (US); Junzheng CHEN, Concord, MA (US); Frank Yongzhen FAN, Cambridge, MA (US); Dhanya PUTHUSSERI, Cambridge, MA (US); Grace O'DWYER, Brighton, MA (US); Humberto ROJAS, Roslindale, MA (US)

(21) Appl. No.: 18/928,925

(22) Filed: Oct. 28, 2024

Related U.S. Application Data
(60) Provisional application No. 63/546,421, filed on Oct. 30, 2023.

(51) Int. Cl. H01M 50/204; H01M 4/66; H01M 10/0525; H01M 10/054; H01M 50/51; H01M 50/512

(52) U.S. Cl. CPC H01M 50/204; H01M 4/661; H01M 10/0525; H01M 10/054; H01M 50/51; H01M 50/512

(57) ABSTRACT

An electrochemical cell system includes a first electrochemical cell including a first anode current collector, a first anode, a first cathode current collector, a first cathode, and a first separator. The first cathode has a first composition such that the first electrochemical cell has a first energy density, and a first power density at a predetermined temperature. A second electrochemical cell includes a second anode, a second cathode current collector, a second cathode, and a second separator. The second cathode has a second composition different from the first composition such that the second electrochemical cell has a second energy density that is less than the first energy density, and a second power density at the predetermined temperature that is greater than the first power density. The first electrochemical cell may include a first electrolyte different from a second electrolyte of the second electrochemical cell.

### CROSS-REFERENCE TO RELATED APPLICATIONS

The present application claims priority to and benefit of U.S. Provisional Application No. 63/546,421, filed Oct. 30, 2023, and entitled “Electrochemical Cell Systems with Divergent Cell Chemistries and Methods of Producing the Same,” the entire disclosure of which is hereby incorporated by reference herein.

### TECHNICAL FIELD

Embodiments described herein relate to electrochemical cell systems including electrochemical cells with dissimilar chemistries and methods of making the same.

### BACKGROUND

A battery or an electrochemical cell typically includes a single anode and a single cathode, each with one set of performance-related properties (e.g., capacity, power, thickness, chemistry, safety, etc.). Therefore, traditional pouch or prismatic electrochemical cells are limited in their capabilities due to housing only one electrode material set and a specific electrolyte composition. This leads to inherent trade-offs in performance, such as energy density, power output, fast charge capability and low-temperature functionality. For example, an electrochemical cell can have high energy density but low power density. Batteries with limited energy density might not be suitable for high-energy-demand applications, such as electric vehicles or large-scale energy storage systems, where extended operation without frequent charging is required.

### SUMMARY

Embodiments described herein relate to electrochemical cell systems including electrochemical cells with dissimilar chemistries formed into a single cell (e.g., a single pouch or prismatic cell). In some embodiments, electrochemical cells and electrochemical cell systems include a first electrochemical cell and a second electrochemical cell connected in parallel or series. In some embodiments, both electrochemical cells include an anode current collector, an anode disposed on the anode current collector, a cathode current collector, a cathode disposed on the cathode current collector, a separator disposed between the anode and the cathode. In some embodiments, the first electrochemical cell includes a first electrolyte in contact with at least a first anode and a first cathode, and the second electrochemical cell includes a second electrolyte in contact with at least a second anode and a second cathode. In some embodiments, the first electrochemical cell can have different performance properties from the second electrochemical cell. For example, the first electrochemical cell can have a high energy density while the second electrochemical cell can have a high power density. In some embodiments, the first electrochemical cell is fluidically isolated from the second electrochemical cell such that the first electrolyte is fluidically isolated from the second electrolyte. In some embodiments, the first electrochemical cell can have a battery chemistry (e.g., cathode composition), thickness, or any other physical/chemical property different from those properties of the second electrochemical cell. In such embodiments, the composition of the first electrolyte is different from the composition of the second electrolyte. Specifically, during a discharge or charge cycle of the electrochemical cell system, the first electrolyte and the second electrolyte may include different metal ions selected from the group consisting of lithium-ion, sodium-ion, potassium-ion, magnesium-ion, calcium-ion, copper-ion, zinc-ion, and aluminum-ion. For example, the first electrolyte composition can include lithium-ions, and the second composition can include sodium-ions or potassium-ions. In some embodiments, the electrochemical cell system can include a third electrochemical cell or any number of additional electrochemical cells.

In some embodiments, an electrochemical cell system includes: a first electrochemical cell, including: a first anode current collector, a first anode disposed on the first anode current collector, a first cathode current collector, a first cathode disposed on the first cathode current collector, and a first separator disposed between the first anode and the first cathode; and a second electrochemical cell, including: a second anode, a second cathode current collector, a second cathode disposed on the second cathode current collector, and a second separator disposed between the second anode and the second cathode. The first cathode has a first composition such that the first electrochemical cell has a first energy density, and a first power density at a predetermined temperature; and the second cathode has a second composition different from the first composition such that the second electrochemical cell has a second energy density that is less than the first energy density, and a second power density at the predetermined temperature that is greater than the first power density. In some embodiments, the first composition comprises lithium-ions, and the second composition comprises sodium-ions.

In some embodiments, the electrochemical cell system can include a third electrochemical cell or any number of additional electrochemical cells.

In some embodiments, an electrochemical cell system includes a first electrochemical cell, including: a first anode current collector, a first anode disposed on the first anode current collector, a first cathode current collector, a first cathode disposed on the first cathode current collector, a first separator disposed between the first anode and the first cathode, and a first electrolyte in contact with at least the first anode and the first cathode; and a second electrochemical cell, comprising: a second anode, a second cathode current collector, a second cathode disposed on the second cathode current collector, a second separator disposed between the second anode and the second cathode, and a second electrolyte in contact with at least the second anode and the second cathode. The second electrolyte is different from the first electrolyte and the first electrochemical cell is fluidically isolated from the second electrochemical cell such that the first electrolyte is fluidically isolated from the second electrolyte.

### BRIEF DESCRIPTION OF THE DRAWINGS

FIG. 1 is a schematic illustration of an electrochemical cell system including a first electrochemical cell and a second electrochemical cell, according to an embodiment.

FIG. 2 is a schematic illustration of an electrochemical cell system including a first electrochemical cell and a second electrochemical cell coupled to each other in series, according to an embodiment.

FIG. 3 is a schematic illustration of an electrochemical cell system including a first electrochemical cell and a second electrochemical cell coupled to each other in parallel, according to an embodiment.

FIG. 4 is a schematic illustration of an electrochemical cell system including a first electrochemical cell and a second electrochemical cell coupled to each other in series with a shared current collector, according to an embodiment.

FIG. 5 illustrates an electrochemical cell system including a first electrochemical cell and a second electrochemical cell coupled to each other in series, according to an embodiment.

FIG. 6 illustrates an electrochemical cell system including a first electrochemical cell and a second electrochemical cell coupled to each other in parallel, according to an embodiment.

FIG. 7 is a schematic illustration of an electrochemical cell system including a first electrochemical cell and a second electrochemical cell coupled to each other in series with a shared current collector, according to an embodiment.

FIG. 8 shows voltage profiles of an electrochemical cell system including a first electrochemical cell having a first composition and a second electrochemical cell having a second composition different from the first composition, coupled to each other in parallel during charge and discharge, as compared to a comparative electrochemical cell that has a uniform composition.

FIGS. 9A-9B show voltage profiles of a comparative Na-ion electrochemical cell at various charge/discharge rates at 25° C.; FIG. 9A shows voltage versus capacity retention plots for a comparative Na-ion cell at various charge/discharge rates at 25° C. FIG. 9B shows plots of mid-discharge voltages at different discharging current rates versus capacity retention percentage for the comparative Na-ion electrochemical cell; FIG. 9C shows plots of charge/discharge direct current resistance (DCR Chg/DChg), and charge/discharge power vs. number of pulses for the comparative Na-ion electrochemical cell.

FIGS. 10A-10B show voltage profiles of a comparative Li-ion electrochemical cell at various charge/discharge rates at 25° C. FIG. 10A shows voltage versus capacity retention plots for a comparative Li-ion cell at various charge/discharge rates at 25° C. FIG. 10B shows plots of mid-discharge voltages at different discharging current rates versus capacity retention percentage for the comparative Li-ion electrochemical cell. FIG. 10C shows plots of charge/discharge direct current resistance (DCR Chg/DChg), and charge/discharge power vs. number of pulses for the comparative Li-ion electrochemical cell.

FIGS. 11A-11D shows voltage versus capacity retention plots for the comparative Na-ion electrochemical, the comparative Li-ion electrochemical cell and an electrochemical cell system including Na-ion cell and Li-ion cell connected to each other in parallel (referred herein as Na—Li ion electrochemical cell), at different charge/discharge rates (i.e., C/10, C/3, 1C and 3C, respectively) at 25° C.

FIG. 12 shows plots of charge/discharge direct current resistance (DCR Chg/DChg), and charge/discharge power vs. number of pulses for the Na—Li ion electrochemical cell.

FIGS. 13A-13D show current profile of the comparative Na-ion electrochemical, the comparative Li-ion electrochemical cell and the Na—Li ion electrochemical cell at different charge/discharge rates (i.e., C/10, C/3 and 1C, respectively) at 25° C. with respect to capacity and voltage. FIG. 13A top panels show discharge at C/10 discharge rate (top-left panel) and charge at C/10 charge rate (top-right panel) vs capacity, while FIG. 13A bottom panels show discharge at C/10 discharge rate (bottom-left panel) and charge at C/10 charge rate (bottom-right panel) vs voltage. FIG. 13B top panels show discharge at C/3 discharge rate (top-left panel) and charge at C/10 charge rate (top-right panel) vs capacity, while FIG. 13B bottom panels show discharge at C/3 discharge rate (bottom-left panel) and charge at C/10 charge rate (bottom-right panel) vs voltage. FIG. 13C top panels show discharge at 1C discharge rate (top-left panel) and charge at C/10 charge rate (top-right panel) vs capacity, while FIG. 13C bottom panels show discharge at 1C discharge rate (bottom-left panel) and charge at C/10 charge rate (bottom-right panel) vs voltage. FIG. 13D top panels show discharge at 3C discharge rate (top-left panel) and charge at C/10 charge rate (top-right panel) vs capacity, while FIG. 13D bottom panels show discharge at 3C discharge rate (bottom-left panel) and charge at C/10 charge rate (bottom-right panel) vs voltage.

### DETAILED DESCRIPTION

Embodiments described herein relate to electrochemical cell systems including electrochemical cells with dissimilar chemistries and methods of making the same. More specifically, electrochemical cell systems described herein may include multiple anodes, multiple cathodes, and multiple electrolytes with dissimilar compositions within a single cell (e.g., a pouch or prismatic cell).

Specifically, embodiments presented herein relate to a single pouch or prismatic cell including two or more electrochemical cells connected in parallel and/or series. In some embodiments, an electrochemical cell may include an anode current collector, an anode disposed on the anode current collector, a cathode current collector, a cathode disposed on the cathode current collector, and a separator disposed between the anode and the cathode, and an electrolyte in contact with at least the anode and the cathode. In some embodiments, at least two electrochemical cells can have different performance properties from each other. For example, one electrochemical cell can have a high energy density while the second electrochemical cell can have a high power density. In some embodiments, at least two electrochemical cells are fluidically isolated such that the electrolyte of each cell is fluidically separated from each other. In some embodiments, at least two electrochemical cells can have different battery chemistry, thickness, or any other physical/chemical property different from those properties of the second electrochemical cell. In some embodiments, the electrochemical cell system can include two electrochemical cells, one having a first cathode including a first alkali metal such as Li, Na, or K, and the other having a second cathode include a second alkali metal such as Li, Na, or K, which is different from the first alkali metal. The two electrochemical cells may be electrically coupled to each other in series or in parallel.

A conventional battery or an electrochemical cell typically includes a single anode and a single cathode, each with one set of performance-related properties (e.g., capacity, power, thickness, chemistry). Therefore, cells with a single anode and a single cathode can offer a fixed performance due to their limited capacity to house only one specific chemistry of electrode materials and electrolyte tailored for that particular electrode chemistry. This results in cells having performance properties that are excellent in some areas but lacking in other areas. In some cases, a conventional cell can have high energy density but low power density. In some cases, a conventional cell can operate with high power density, but also have high heat generation. In some cases, while a high-energy cell benefits from advanced cathode and anode materials, the conventional cell may suffer in cold temperatures. In some cases, a conventional cell can be fully charged at a low charging rate, but only partially charged at a high charging rate. In some cases, a conventional cell can operate stably within the normal voltage window but suffer fast performance fades outside the normal voltage window. Achieving complementary operational properties, e.g., high power density and energy density has been challenging.

Efforts to enhance cell performance have involved blending electrode materials with diverse properties. However, optimizing the electrolyte to work optimally with such blended materials presents a challenge. The electrolyte can only be tailored to suit one of the blended materials, limiting the full utilization of each material's potential. This constraint restricts the ability to unlock the best performance from all materials in the cell. Moreover, there have been attempts to connect different material chemistries at the module- or pack-level. However, this approach compromises the flexibility in designing these larger units. Integrating various chemistries at this scale is difficult and can lead to challenges in maintaining safety, uniformity, and efficiency. As a result, the potential benefits of using multiple material combinations are hindered by the limitations imposed by module and pack designs. Embodiments of systems described herein offers a solution that facilitates the incorporation of electrochemical cells featuring disparate chemistries (e.g., sodium and lithium chemistries) into a singular pouch/prismatic cell capable of delivering desired attributes such as power, energy, cycle life, and low-temperature performance. Embodiments of systems described herein enable connection of the cells having different compositions in parallel or series configurations, which can unlock the potential for elevated capacity or voltage within a solitary pouch/prismatic cell.

Further, embodiments of systems described herein that include divided electrochemical cells, may provide one or more benefits including, for example: (1) enabling coupling or integration of multiple cathodes, anodes, and electrolytes with different physicochemical properties into a single cell, which can lead to improved electrochemical performance (e.g., cycle life, power, energy density fast charge, safety and low temperature performance); (2) allowing optimization of chemistry of each electrode and electrolyte composition within the divided electrochemical cell(s), thereby allowing the use of best performance from different chemistries to be simultaneously achieved and work synergistically; (3) allowing separation of electrolytes of unit cells with the divided electrochemical cells(s) from each other; (4) improving safety of the electrochemical cell(s) and reducing the risk of excessive heat generation during operation by combining high energy and high-power chemistry with low cell resistance, thereby enabling less heat generation during high power operation; (5) enabling parallel or series configurations, which can be used for elevated capacity or voltage within a single cell; (6) facilitating low cell resistance by enabling weld-free contact to connect individual unit electrochemical cells; (7) enabling better correlation between state of charge (SOC) and cell voltage by combining voltage profile from different chemistries; (8) inhibit issues with undesirable metal plating during fast charging; (9) improve tolerance to over discharging; (10) enabling low temperature performance by providing one electrochemical cell that has better low temperature rate performance than a second electrochemical cell in the system, for example, due to lower cell resistance, better ion transport and lower solvation/desolvation energy; (11) enabling fast charge capability, for example, by including a Na-ion electrochemical cell in the cell system that could allow faster charge rate; (12) providing fast charge safety, for example, depending on the voltage profile of the different composition electrochemical cells; (13) inhibiting plating of Li on a Li-ion cell included in the system at high state of charge by distributing current between cells having different chemical compositions; (14) reducing heat generation by including an electrochemical cell having lower resistance that acts as a heat sink, delaying heat release of one electrochemical cell by using aluminum current collector, and having a high flash point solver, thereby increasing safety; and (15) enabling more accurate monitoring of state of charge and/or state of health by a battery monitoring system.

The divided electrochemical cells of the present disclosure may exhibit higher power density, higher energy density, longer cycle life, improved safety or combination thereof compared to the electrochemical cells with single anode and cathode. These enhanced electrochemical properties can contribute to better overall battery performance.

All definitions, as defined and used herein, should be understood to control over dictionary definitions, definitions in documents incorporated by reference, and/or ordinary meanings of the defined terms.

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

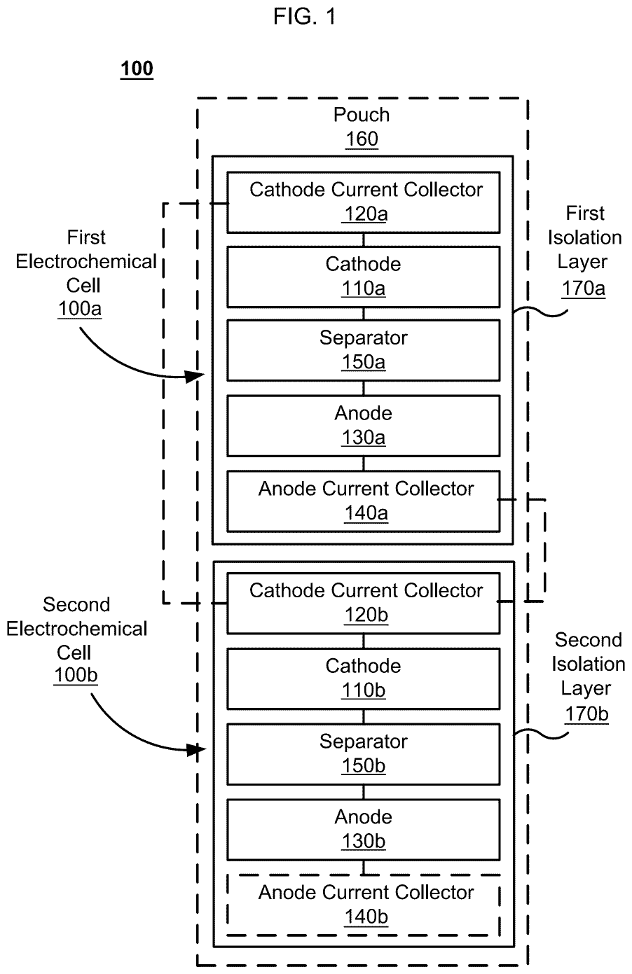

FIG. 1 is a schematic illustration of an electrochemical cell system 100 including a first electrochemical cell 100a and a second electrochemical cell 100b, according to an embodiment.

The first electrochemical cell 100a includes a first anode 130a disposed on a first anode current collector 140a, a first cathode 110a disposed on a first cathode current collector 120a, and a first separator 150a disposed between the first anode 130a and the first cathode 110a. The second electrochemical cell 100b includes a second anode 130b, a second cathode 110b disposed on a second cathode current collector 120b, and a second separator 150b disposed between the second anode 130b and the second cathode 110b. In some embodiments, optionally, the second electrochemical cell 100b may include a second anode current collector 140b on which the second anode 130b is disposed. In some embodiments, the second anode current collector 140b may be excluded and the second anode 130b may instead be disposed on the first cathode current collector 120a, for example, on a surface of the first cathode current collector 120a that is opposite another surface of the first cathode current collector 120a on which the first cathode 110a is disposed. In such embodiments, the first cathode current collector 120a may serve as a shared current collector used by each of the first cathode 110a and the second anode 130b, as described in further detail herein.

In some embodiments, the first electrochemical cell 100a and the second electrochemical cell 100b can be disposed in a single pouch 160. In some embodiments, the electrochemical cell system 100 includes a first isolation layer 170a at least partially enclosing the first electrochemical 110a, and a second isolation layer 170b at least partially enclosing the second electrochemical cell 100b to fluidically isolate the first electrochemical cell 100a from the second electrochemical cell 100b. In some embodiments, the electrochemical cell system 100 further includes one or more electrochemical cells electrically connected to the first and the second electrochemical cells 100a and 100b.

In some embodiments, the first electrochemical cell 100a may be electrically coupled to the second electrochemical cell 100b in series. For example, In some embodiments, the electrochemical cell system 100 is arranged anode-to-cathode in the series configuration, i.e., the anode current collector 140a of the first electrochemical cell 100a is electrically coupled to the cathode current collector 120b of the second electrochemical cell 100b, or conversely, the cathode current collector 120a of the first electrochemical 100a is electrically coupled to the anode current collector 140b of the second electrochemical cell 100b, to form a single cell. In embodiments in which the second anode current collector 120b is not included in the electrochemical cell system 100, the second anode 130b may be coupled in series by disposing the second anode 130b on a second surface of the first cathode current collector 120a opposite a first surface of the first cathode current collector on which the first cathode 110a is disposed, or vice versa.

In some embodiments, the first anode current collector 140a includes copper and the second anode current collector 140b includes aluminum, for example, in embodiments in which the first cathode 110a includes Li-ion, and the second cathode 110b includes Na-ion or K-ion, as described in further detail herein. Moreover, the second cathode current collector 120b to which the first anode current collector 140a may be coupled in the series configuration may include aluminum. In some embodiments, the second cathode current collector 120b may also include aluminum. In some embodiments, including an aluminum current collector in the second electrochemical cell 100b that may include Na-ion or K-ion may be beneficial as the Na-ion and K-ions included in the second electrochemical cell 100b may have negligible reactivity with the aluminum electrodes. Some other advantages of using an aluminum second anode current collectors 140b may include, but are not limited to weight reduction, improvement in specific energy density of the second electrochemical cell, reduction in cost, enabling series connection (e.g., when a current collector is shared between the first electrochemical cell 100a and the second electrochemical cell 100b, as described herein), reduction in layers included in the isolation layers 170a, 170b or pouch 160, and better coupling between current collectors in parallel configuration.

In some embodiments, the first cathode 110a is disposed on a first side of the first cathode current collector 120a, and the second anode 130b may be disposed on a second side of the first cathode current collector 120a opposite the first side, such that the first cathode current collector 120a acts as a cathode current collector for the first electrochemical cell 100a and as an anode current collector for the second electrochemical cell 100b. In such embodiments, the first anode current collector 140a may include copper, and the first cathode current collector 120a may include aluminum, and the second cathode current collector 120b may include aluminum. In some embodiments, each of the first anode and cathode current collectors 140a, 120a, and the second anode and cathode current collector 140b, 120b, may include aluminum.

In some embodiments, coupling the first electrochemical cell 100a in series with the second electrochemical cell 100b may enable constant low current charge or discharge. For example, the first electrochemical cell 100a (e.g., a Li-ion cell) and the second electrochemical cell 100b (e.g., a Na-ion or K-ion cell) may have similar voltage windows and charge/discharge rates. However, the second electrochemical cell 100b having a different composition than the first electrochemical cell may have a lower electronic resistance than the first electrochemical cell 100a thus generating less heat than the first electrochemical cell 100a. This may allow the second electrochemical cell 100b to serve as a heat sink for the first electrochemical cell 100a. In some embodiments, coupling the first electrochemical cell 100a in series with the second electrochemical cell 100b may additionally, or alternatively, enable constant or pulse high voltage charge or discharge. For example, the second electrochemical cell 100b, which may have a lower electronic resistance than the first electrochemical cell 100a, may discharge first to satisfy a power or load demand on the system 100.

In some such embodiments, the second cathode current collector 110b of the second electrochemical cell 100b (e.g., a Na-ion or K-ion cell) may include aluminum, which can allow for high-power discharge, thus allowing the second electrochemical cell 100b to survive discharge under continuous high-power discharge conditions. Moreover, in some such embodiments, the second anode current collector 140b may include a material (e.g., carbon, disordered carbon, etc.) that can manage or withstand overcharging better than the first electrochemical cell 100a. In some embodiments, the first electrochemical cell 100a may be electrically coupled to the second electrochemical cell 100b in parallel. For example, in some embodiments, the electrochemical cell system 100 can be arranged anode-to-anode or cathode-to-cathode in the parallel configuration, i.e., the first cathode current collector 120a is electrically coupled to the second cathode current collector 120b, or the first anode current collector 140a is electrically coupled to the second anode current collector 140b, to form a single cell. The electrochemical cells 100a and 100b can be electrically coupled in series or parallel by direct contact between the respective current collectors 120a, 120b, 140a, 140b, or via welding respective tabs of the current collectors.

In some embodiments, coupling the first electrochemical cell 100a in parallel with the second electrochemical cell 100b may enable constant low current charge or discharge. For example, the first electrochemical cell 100a (e.g., a Li-ion cell) and the second electrochemical cell 100b (e.g., a Na-ion or K-ion cell) may have similar voltage windows and charge/discharge rates but, the different chemical composition second electrochemical cell 100b may have a lower electronic resistance than the first electrochemical cell 100a as described with respect to the series configuration. This may allow the second electrochemical cell 100b to serve as a heat sink for the first electrochemical cell 100a. Moreover, the lower resistance of the second electrochemical cell 100b may allow a larger portion of current to flow through the second electrochemical cell 100b, which may reduce polarization and drop in power output of system 100 during discharge and/or inhibit dendrite formation during charge.

In some embodiments, the first anode 130a can be different from the second anode 130b. For example, the first anode 130a can be different from the second anode 130b in chemical composition, thickness, density, porosity, and/or any other properties. In some embodiments, the first anode 130a can be the same as the second anode 130b. In some embodiments, the first anode 130a and/or the second anode 130b (collectively referred to herein as “anodes 130”) can include graphite, lithium metal (Li), sodium metal (Na), silicon oxide (SiO), graphite, silicon, carbon, lithium-intercalated carbon, lithium nitrides, lithium alloys, lithium alloy forming compounds, sodium alloys, sodium alloy forming compounds, sodium titanate (Na₂Ti₃O₇), Na₃V₂ (PO₄)₃, sodium vanadates, sodium insertion compounds, potassium titanate, potassium insertion compounds, or any other anode active material, inclusive of all combinations thereof. In some embodiments, the lithium alloy forming compounds can include silicon, bismuth, boron, gallium, indium, zinc, tin, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon carbide, and/or silicon-graphite composite.

In some embodiments, the first cathode 110a and second cathodes 110b (collectively referred to herein as “cathodes 110”) can be different from each other. For example, the first cathode 110a can be different from the second cathode 110b in chemical composition, thickness, density, porosity, and/or any other properties. In some embodiments, the composition of the first cathode 110a is different than the composition of the second cathode 110b. In some embodiments, the first composition may include lithium-ions (e.g., a lithium active material), and the second composition may include sodium-ions or potassium ions (e.g., a sodium or potassium active material). In some embodiments, the first composition may include lithium-ions (e.g., a lithium active material), and the second composition may include sodium-ions (e.g., a sodium active material). In some embodiments, the first cathode 110a can include Lithium cobalt oxide (LCO), lithium nickel manganese cobalt oxide (NMC), lithium iron phosphate (LFP), or any other first cathode 110a active material, inclusive of all combinations thereof. In some embodiments, the second cathode 110b can include sodium cobalt oxide (NCO), sodium iron phosphate (NFP), sodium nickel cobalt manganese oxide (NNMC), sodium manganese oxide, sodium vanadium oxide, sodium sulfur compounds, Prussian blue/white analogues, potassium cobalt oxide (KCO), potassium iron phosphate (KFP), potassium nickel cobalt manganese oxide (KNMC), potassium manganese oxide, potassium vanadium oxide, any other suitable second cathode 110b active material, inclusive of all combinations thereof.

In some embodiments, the first electrochemical cell 100a and/or the second electrochemical cell 100b can include one or more electrolyte solutions. Electrolyte solutions can include ethylene carbonate (EC), gamma-butyrolactone (GBL), Lithium bis(fluorosulfonyl)imide (LiFSI), trioctyl phosphate (TOP), propylene carbonate (PC), dimethoxyethane (DME), bis(trifluoromethanesulfonyl)imide (TSFI), Li_{1.4}Al_{0.4} Ti_{1.6} (PO₄)₃ (LATP), lithium hexafluorophosphate (LiPF₆), lithium bis(trifluoromethanesulfonyl)imide (LiTFSI), lithium borate (LiBOB), lithium carbonate (Li₂CO₃), any other suitable salt, and any combinations thereof. Additional examples of active materials, conductive materials, and electrolyte solutions that can be included in the first electrochemical cell 100a and/or the second electrochemical cell 100b are described in U.S. Pat. No. 9,484,569, entitled, “Electrochemical Slurry Compositions and Methods of Preparing the Same,” (“the '569 patent”) and in U.S. Pat. No. 9,437,864 entitled, “Asymmetric Battery Having a Semi-Solid Cathode and High Energy Density Anode,” registered Sep. 6, 2016 (“the '864 patent), the disclosures of which are incorporated herein by reference in their entirety.

In some embodiments, the first electrochemical cell 100a includes a Li-ion cell and includes a first electrolyte. Moreover, the second electrochemical cell 100b includes a Na-ion or K-ion cell and includes a second electrolyte that is different from the first electrolyte. In some embodiments, the first electrolyte includes ethylene carbonate (EC), gamma-butyrolactone (GBL), Lithium bis(fluorosulfonyl)imide (LiFSI), trioctyl phosphate (TOP), propylene carbonate (PC), dimethoxyethane (DME), bis(trifluoromethanesulfonyl) imide (TSFI), Li_{1.4}Al_{0.4}Ti_{1.6}(PO₄)₃ (LATP), lithium hexafluorophosphate (LiPF₆), lithium bis(trifluoromethanesulfonyl) imide (LiTFSI), lithium borate (LiBOB), lithium carbonate (Li₂CO₃) and any combinations thereof. The second electrolyte may include aqueous electrolyte, EC, PC, DMC, sodium bis(fluorosulfonyl)imide (NaFSI), hexafluorophosphate sodium (NaPF₆), NaClO₄, sodium bis(trifluoromethanesulfonyl)imide (NaTFSI), sodium difluoro (oxalate) borate (NaDFOB), sodium bis(oxalate) borate) (NaBOB), solutions of potassium nitrate (KNO₃), potassium sulphate (K₂SO₄), potassium chloride (KCl), potassium bis(fluorosulfonyl)imide (KFSI), potassium hexafluorophosphate (KPF6), potassium bis(trifluoromethanesulfonyl)imide (KTFSI) any other suitable salt, and any combinations thereof.

In some embodiments, the first electrolyte or the second electrolyte may include one or more solvents including, for example, bis-(2-fluoro-ethyl)-ether, 1,2-diethoxyethane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, fluoroethylene carbonate, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, fluoroether, fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl) orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanessulfonate, dimethyl carbonate, 1,3-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, fluoroethylene carbonate, tris-(trimethylsilyl) phosphate (TMSP), trimethoxy (3,3,3-trifluoropropyl) silane (TTS), pentafluorophenyltriethoxysilane (TPS), boric acid tris(trimethylsilyl) ester (TMSB), tris-(pentafluorophenyl) silane (TPFPS), 1,10-sulfonyldiimidazole (SDM), (pentafluorophenyl)diphenylphosphine (PFPDPP), tributyl phosphate, triphenyl phosphate, tris(2,2,2-trifluoroethyl) phosphate, bis(2,2,2-trifluoroethyl) methyl phosphate, trimethyl phosphite, triphenyl phosphite, tris(2,2,2-trifluoroethyl) phosphite, dimethyl methylphosphonate, diethyl ethylphosphonate, diethyl phenylphosphonate, bis(2,2,2-trifluoroethyl)methylphosphonate, hexamethylphosphoramide, hexamethoxyphosphazene (cyclo-tris(dimethoxyphosphonitrile), hexamethoxycyclotriphosphazene), and/or hexafluorophosphazene (hexafluorocyclotriphosphazene).

In some embodiments, the first electrolyte may include one or more salts including, for example, lithium hexafluoroarsenate (LiAsF₆), lithium perchlorate (LiClO₄), lithium difluoro oxalato borate anion (LiBF₂ (C₂O₄)), lithium iodide (LiI), lithium bromide (LiBr), lithium chloride (LiCl), lithium hydroxide (LiOH), lithium nitrate (LiNO₃), lithium 2-trifluoromethyl-4,5-dicyanoimidazole (LiTDI), lithium sulfate (Li₂SO₄), and/or lithium difluorophosphate (LiPO₂F₂), and the second electrolyte may include Na or K analogues of any of these salts.

In some embodiments, the first separator 150a and/or the second separator 150b (collectively referred to herein as “separators 150”) can include a selectively permeable membrane, such that the anodes 130 and cathodes 110 are fluidically and/or chemically isolated from each other. This can allow for independent optimization of the properties of each of the electrodes. Examples of electrochemical cells that include a separator with a selectively permeable membrane that can chemically and/or fluidically isolate the anode from the cathode while facilitating ion transfer during charge and discharge of the cell are described in U.S. Patent Publication No. 2019/0348705, entitled, “Electrochemical Cells Including Selectively Permeable Membranes, Systems and Methods of Manufacturing the Same,” filed Jan. 8, 2019 (“the '705 publication”), the disclosure of which is incorporated herein by reference in its.

Both the first electrochemical cell 100a and the second electrochemical cell 100b described herein have an energy density and a power density at a predetermined temperature. In some embodiments, the energy density of the first electrochemical cell 100a is higher than the energy density of the second electrochemical cell 100b at a predetermined temperature. In such embodiments, the energy density of the first electrochemical cell 100a is at least 3%, at least 5%, at least 7%, at least 10%, at least 15%, at least 20%, at least 25%, at least 30%, at least 35%, at least 40%, at least 45%, at least 50%, at least 55%, at least 60%, at least 65%, at least 70%, at least 75% greater than the energy density of the second electrochemical cell 100b. In some embodiments, the energy density of the first electrochemical cell 100a is in a range of about 5% to about 30%, inclusive, higher than the energy density of the second electrochemical cell 100b. In some embodiments, the energy density of the first electrochemical cell 100a is in a range of about 7% to about 25%, inclusive, higher than the energy density of the second electrochemical cell 100b. In some embodiments, the energy density of the first electrochemical cell 100a is in a range of about 10% to about 20%, inclusive, higher than the energy density of the second electrochemical cell 100b. In some embodiments, the energy density of the first electrochemical cell 100a is in a range of about 15% to about 30%, inclusive, higher than the energy density of the second electrochemical cell 100b. In some embodiments, the energy density of the first electrochemical cell 100a is about 10% higher than the energy density of the second electrochemical cell 100b. In some embodiments, the energy density of the first electrochemical cell 100a is about 15% higher than the energy density of the second electrochemical cell 100b. In some embodiments, the energy density of the first electrochemical cell 100a is about 20% higher than the energy density of the second electrochemical cell 100b. All such ranges are envisioned and should be considered to be within the scope of the present disclosure.

In some embodiments, the power density of the second electrochemical cell 100b is higher than the energy density of the first electrochemical cell 100a at a predetermined temperature. In such embodiments, the power density of the second electrochemical cell 100b is at least 10%, at least 15%, at least 20%, at least 25%, at least 30%, at least 35%, at least 40%, at least 45%, at least 50%, at least 55%, at least 60%, at least 65%, at least 70%, at least 75% higher than the power density of the first electrochemical cell 100a at a temperature of about −20 degrees Celsius. In some embodiments, the power density of the second electrochemical cell 100b is about 20% to about 60%, inclusive, higher than the energy density of the first electrochemical cell 100a at a temperature of −20 degrees Celsius. In some embodiments, the power density of the second electrochemical cell 100b is about 25% to about 55%, inclusive, higher than the energy density of the first electrochemical cell 100a at a temperature of −20 degrees Celsius. In some embodiments, the power density of the second electrochemical cell 100b is about 30% to about 50%, inclusive, higher than the energy density of the first electrochemical cell 100a at a temperature of −20 degrees Celsius. In some embodiments, the power density of the second electrochemical cell 100b is about 35% to about 45%, inclusive, higher than the energy density of the first electrochemical cell 100a at a temperature of −20 degrees Celsius. In some embodiments, the power density of the second electrochemical cell 100b is about 20% higher than the energy density of the first electrochemical cell 100a at a temperature of −20 degrees Celsius. In some embodiments, the power density of the second electrochemical cell 100b is about 25% higher than the energy density of the first electrochemical cell 100a at a temperature of −20 degrees Celsius. In some embodiments, the power density of the second electrochemical cell 100b is about 30% higher than the energy density of the first electrochemical cell 100a at a temperature of −20 degrees Celsius. In some embodiments, the power density of the second electrochemical cell 100b is about 35% higher than the energy density of the first electrochemical cell 100a at a temperature of −20 degrees Celsius. In some embodiments, the power density of the second electrochemical cell 100b is about 40% higher than the energy density of the first electrochemical cell 100a at a temperature of −20 degrees Celsius. In some embodiments, the power density of the second electrochemical cell 100b is about 45% higher than the energy density of the first electrochemical cell 100a at a temperature of −20 degrees Celsius. All such ranges are envisioned and should be considered to be within the scope of the present disclosure.

In some embodiments, the first electrochemical cell 100a can be a high energy density cell, and/or the second electrochemical cell 100b can be a high power density cell. In some embodiments, the first electrochemical cell 100a and/or the second electrochemical cell 100b can be a high energy density cell. In some embodiments, the first electrochemical cell 100a and/or the second electrochemical cell 100b can be a high energy density cell with high heat production. In some embodiments, the first electrochemical cell 100a and/or the second electrochemical cell 100b can be a high energy density cell that performs with low efficiency at low temperatures. In some embodiments, the first electrochemical cell 100a and/or the second electrochemical cell 100b can have high capacity retention. In some embodiments, the first electrochemical cell 100a can be a high power density cell while the second electrochemical cell 100b can be a high energy density cell.

In some embodiments, the first electrochemical cell 100a can be a high energy density cell with high heat production while the second electrochemical cell 100b can be a high energy density cell that performs with low efficiency at low temperatures. In some embodiments, the first electrochemical cell 100a can have a high energy density while the second electrochemical cell 100b can have high capacity retention. Having a high energy density cell (e.g., one of the first electrochemical cell 100a or the second electrochemical cell 100b) that may have inferior low temperature performance, coupled in series or parallel with a high power density cell that has superior low temperature performance enables superior energy density and power density performance over a wide range of temperatures relative to cells that have the same composition throughout.

In some embodiments, the first electrochemical cell 100a may have a first fast charge current limit at given or predetermined temperature without causing metal plating, safety event and performance degradation and the second electrochemical cell may have a second fast charge current limit at the predetermined temperature without causing metal plating, a safety event, and/or performance degradation. The second fast charge current limit may be higher than the first fast charge current limit at the predetermined temperature. In some embodiment, the first electrochemical cell 100a may be configured such that it cannot be discharged below 1.5V over long period of time or be over discharged without causing performance degradation or a safety event. In contrast, the second electrochemical cell 100b may be configured to be discharged to less than 1.5V (e.g., to 0V) or over discharged without causing performance degradation or a safety event.

Metal plating can occur when a battery is overcharged or charged too quickly, leading to the deposition of metal (e.g., lithium in a Li-ion battery) on the battery's electrodes. This can result in several issues, including capacity loss, safety hazards, and reduced cycle life. The electrochemical cell systems according to multiple embodiments described herein may alleviate metal plating issues, leading to enhanced battery performance and safety.

In some embodiments, the isolation layer 170a and 170b (collectively referred to herein as “isolation layers 170”) includes polymer materials such as polyethylene terephthalate (PET), polybutylene terephthalate (PBT), nylon, high-density polyethylene (HDPE), oriented polypropylene (o-PP), polyvinyl chloride (PVC), polyimide (PI), polysulfone (PSU), and their combinations. In some embodiments, the isolation layers 170 can have a thickness of about 0.15 mm, about 0.2 mm, or about 0.25 mm, inclusive of all values and ranges therebetween.

In some embodiments, at least a portion of the first isolation layer 170a that partially encloses the first electrochemical cell 100a is disposed on the first cathode current collector 120a and/or the first anode current collector 140a and at least a portion of the second isolation layer 170b that partially encloses the second electrochemical cell 100b is disposed on the second cathode current collector 120b and/or the second anode current collector 140b. In some embodiments, the isolation layers 170 may have corresponding openings. In such embodiments, the corresponding openings may allow electrical coupling of the first electrochemical cell 100a with the second electrochemical cell 100b. Further, such openings may allow the use of shared current collector (not shown in FIG. 1). In such embodiments, the first anode current collector 140a may be electrically coupled to the second cathode current collector 140b such that the first electrochemical cell 100a is coupled to the second electrochemical cell 100b in series, and the first anode current collector 140a is electrically coupled to the second cathode current collector 120b through the corresponding openings of the first isolation layer 170a and the second isolation layer 170b.

In some embodiments, the first cathode current collector 120a may be electrically coupled to the second cathode current collector 120b such that the first electrochemical cell 100a is coupled to the second electrochemical cell 100b in parallel, and the first anode current collector 140a is electrically coupled to the second anode current collector 140b through the corresponding openings of the first isolation layer 170a and the second isolation layer 170b. In some embodiments, the first cathode 110a is disposed on a first side of the first cathode current collector 120a, and the second anode 130b is disposed on a second side of the first cathode current collector 120a opposite the first side through the corresponding openings.

Thus, the isolation layers 170 allow electrical coupling of the first and second electrochemical cells 110a and 110b while fluidically isolating the first electrochemical cell 100a from the second electrochemical cell 100b. Because the two electrochemical cells 110a and 110b are fluidically isolated by the isolation layers, his allows the use of different electrolyte in the first and second electrochemical cells 110a, 110b. For example, the first electrochemical cell 110 can include a first electrolyte that is compatible with and/or provides optimal performance with the chemical composition of the first electrochemical cell 100a, and the second electrochemical cell 110b may include a second electrolyte that is different from the first electrolyte and is compatible with and/or provides optimal performance with the chemical composition of the second electrochemical cell 100b, and the first and second electrolytes are fluidically isolated from each other via the isolation layers 170. For example, a first electrolyte that is suitable for working with Li-ion chemistry can be in contact with the first electrochemical cell 100a (e.g., included with or infused in the first cathode 110a material), and a second electrolyte that is suitable for working with Na-ion or K-ion chemistry can be in contact with the second electrochemical cell (e.g., included in or infused in the second cathode 110b material). In some embodiments, the first isolation layer 170a may also be coupled to the second isolation layer 170b (e.g., via heat sealing or adhesives) to secure the first electrochemical cell 100a to the second electrochemical cell 100b.

In some embodiments, a “high power density cell” can refer to an electrochemical cell with a cell specific power output of at least about 400 W/kg, at least about 450 W/kg, at least about 500 W/kg, at least about 550 W/kg, at least about 600 W/kg, or at least about 650 W/kg, or at least about 700 W/kg, inclusive of all values and ranges therebetween.

In some embodiments, a “high energy density cell” can refer to an electrochemical cell with a cell specific energy density of at least about 250 W·h/kg when discharged at 1C, at least about 300 W·h/kg when discharged at 1C, at least about 350 W·h/kg when discharged at 1C, at least about 400 W·h/kg when discharged at 1C, or at least about 450 W·h/kg when discharged at 1C, inclusive of all values and ranges therebetween. In some embodiments, “high energy density cell” can refer to an electrochemical cell with a specific energy density of at least about 250 W·h/kg when discharged at C/2, at least about 300 W·h/kg when discharged at C/2, at least about 350 W·h/kg when discharged at C/2, at least about 400 W·h/kg when discharged at C/2, or at least about 450 W·h/kg when discharged at C/2, inclusive of all values and ranges therebetween In some embodiments, “high energy density cell” can refer to an electrochemical cell with a specific energy density of at least about 250 W·h/kg when discharged at C/4, at least about 300 W·h/kg when discharged at C/4, at least about 350 W·h/kg when discharged at C/4, at least about 400 W·h/kg when discharged at C/4, or at least about 450 W·h/kg when discharged at C/4, inclusive of all values and ranges therebetween.

In some embodiments, “cell with high heat production” can refer to an electrochemical cell, wherein at least about 20%, at least about 25%, at least about 30%, at least about 35%, at least about 40%, at least about 45%, or at least about 50% of the energy generated is lost as heat, inclusive of all values and ranges therebetween.

In some embodiments, a “cell that performs with low efficiency at low temperatures” can refer to a cell that loses at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99%, or about 100% of its discharge capacity when operated at −20° C., as compared to operation at room temperature, inclusive of all values and ranges therebetween.

In some embodiments, “high capacity retention” can refer to an electrochemical cell that retains at least about 80%, at least about 85%, at least about 90%, at least about 95%, at least about 96%, at least about 97%, at least about 98%, or at least about 99% of its initial discharge capacity after 1,000 cycles, inclusive of all values and ranges therebetween.

In some embodiments, the first anode 130a and/or the second anode 130b can be a semi-solid electrode. In some embodiments, the first cathode 110a and/or the second cathode 110b can be a semi-solid electrode. In comparison to conventional electrodes, semi-solid electrodes can be made (i) thicker (e.g., greater than about 250 μm-up to about 2,000 μm or even greater) due to the reduced tortuosity and higher electronic conductivity of semi-solid electrodes, (ii) with higher loadings of active materials, (iii) with a simplified manufacturing process utilizing less equipment, and (iv) can be operated between a wide range of C-rates while maintaining a substantial portion of their theoretical charge capacity. These relatively thick semi-solid electrodes decrease the volume, mass and cost contributions of inactive components with respect to active components, thereby enhancing the commercial appeal of batteries made with the semi-solid electrodes.

In some embodiments, the semi-solid electrodes described herein, are binderless and/or do not use binders that are used in conventional battery manufacturing. Instead, the volume of the electrode normally occupied by binders in conventional electrodes, is now occupied, by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. As described herein, the first cathode 110a can be different from the second cathode 110b in chemical composition, thickness, density, porosity, and/or any other properties. For example, the first cathode 110a can include an active material that includes Li, and the second cathode 110b can include an active material that includes Na or K, as previously described herein. In some embodiments, the first cathode 110a and/or the second cathode 110b can include a conventional electrode, for example, electrodes including binders.

Since the semi-solid electrodes described herein can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This may substantially increase the overall charge capacity and energy density of a battery that includes the semi-solid electrodes described herein. The use of semi-solid, binderless electrodes can also be beneficial in the incorporation of an overcharge protection mechanism, as generated gas can migrate to the electrode/current collector interface without binder particles inhibiting the movement of the gas within the electrode.

In some embodiments, the electrode materials described herein can be a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in a liquid electrolyte to produce a semi-solid electrode. Examples of electrochemical cells that include a semi-solid and/or binderless electrode material are described in U.S. Pat. No. 8,993,159 entitled, “Semi-solid Electrodes Having High Rate Capability,” registered Mar. 31, 2015 (“the '159 patent”), the disclosure of which is incorporated herein by reference in its entirety.

In some embodiments, the first electrochemical cell 100a and/or the second electrochemical cell 100b can include conventional electrodes (e.g., solid electrodes with binders). In some embodiments, the thickness of the conventional electrodes can be in the range of about 20 μm to about 100 μm, about 20 μm to about 90 μm, about 20 μm to about 80 μm, about 20 μm to about 70 μm, about 20 μm to about 60 μm, about 25 μm to about 60 μm, about 30 μm to about 60 μm, about 20 μm to about 55 μm, about 25 μm to about 55 μm, about 30 μm to about 55 μm, about 20 μm to about 50 μm, about 25 μm to about 50 μm, or about 30 μm to about 50 μm, inclusive of all values and ranges therebetween. In some embodiments, the thickness of the conventional electrodes can be about 20 μm, about 25 μm, about 30 μm, about 35 μm, about 40 μm, about 45 μm, about 50 μm, about 55 μm, or about 60 μm, inclusive of all values and ranges therebetween.

In some embodiments, the first anode 130a and/or the second anode 130b can have a thickness of at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, or at least about 140 μm. In some embodiments, the first anode 130a and/or the second anode 130b can have a thickness of no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, or no more than about 30 μm. Combinations of the above-referenced thicknesses of the first anode 130a and/or the second anode 130b are also possible (e.g., at least about 20 μm and no more than about 150 μm or at least about 50 μm and no more than about 100 μm), inclusive of all values and ranges therebetween. In some embodiments, the first anode 130a and/or the second anode 130b can have a thickness of about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 150 μm.

In some embodiments, the second anode 130b can have a thickness the same or substantially similar to a thickness of the first anode 130a. In some embodiments, the second anode 130b can have a thickness greater than the thickness of the first anode 130a. In some embodiments, the second anode 130b can be thicker than the first anode 130a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the first cathode 110a and/or the second cathode 110b can have a thickness of at least about 50 μm, at least about 60 μm, at least about 70 μm, at least about 80 μm, at least about 90 μm, at least about 100 μm, at least about 110 μm, at least about 120 μm, at least about 130 μm, at least about 140 μm, at least about 150 μm, at least about 200 μm, at least about 250 μm, at least about 300 μm, at least about 350 μm, at least about 400 μm, or at least about 450 μm. In some embodiments, the first cathode 110a and/or the second cathode 110b can have a thickness of no more than about 500 μm, no more than about 450 μm, no more than about 400 μm, no more than about 350 μm, no more than about 300 μm, no more than about 250 μm, no more than about 200 μm, no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, or no more than about 60 μm. Combinations of the above-referenced thicknesses of the first cathode 110a and/or the second cathode 110b are also possible (e.g., at least about 50 μm and no more than about 500 μm or at least about 100 μm and no more than about 300 μm), inclusive of all values and ranges therebetween. In some embodiments, the first cathode 110a and/or the second cathode 110b can have a thickness of about 50 μm, about 60 μm, about 70 μm, about 80 μm, about 90 μm, about 100 μm, about 110 μm, about 120 μm, about 130 μm, about 140 μm, about 150 μm, about 200 μm, about 250 μm, about 300 μm, about 350 μm, about 400 μm, about 450 μm, or about 500 μm.

In some embodiments, the second cathode 110b can have a thickness the same or substantially similar to a thickness of the first cathode 110a. In some embodiments, the second cathode 110b can have a thickness greater than the thickness of the first cathode 110a. In some embodiments, the second cathode 110b can be thicker than the first cathode 110a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the first electrochemical cell 100a and/or the second electrochemical cell 100b can have a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, or at least about 950 μm. In some embodiments, the first electrochemical cell 100a and/or the second electrochemical cell 100b can have a thickness of no more than about 1,000 μm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, or no more than about 150 μm. Combinations of the above-referenced thicknesses of the first electrochemical cell 100a and/or the second electrochemical cell 100b are also possible (e.g., at least about 100 μm and no more than about 1,000 μm or at least about 200 μm and no more than about 500 μm), inclusive of all values and ranges therebetween. In some embodiments, the first electrochemical cell 100a and/or the second electrochemical cell 100b can have a thickness of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1,000 μm.

In some embodiments, the second electrochemical cell 100b can have a thickness the same or substantially similar to a thickness of the first electrochemical cell 100a. In some embodiments, the second electrochemical cell 100b can have a thickness greater than the thickness of the first electrochemical cell 100a. In some embodiments, the second electrochemical cell 100b can be thicker than the first electrochemical cell 100a by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the electrochemical cell system 100 can include a third electrochemical cell (not shown). In some embodiments, the electrochemical cell system 100 can include 4, 5, 6, 7, 8, 9, 10 or more electrochemical cells. In some embodiments, a selection of many different battery properties can be combined into the electrochemical cell system 100 in order to manipulate the performance properties of the electrochemical cell system 100 as desired.

Typical current collectors for lithium cells include copper, aluminum, or titanium for the negative current collector and aluminum for the positive current collector, in the form of sheets or mesh, or any combination thereof. Current collector materials can be selected to be stable at the operating potentials of the positive and negative electrodes of electrochemical cells 100a and 100b. For example, in non-aqueous lithium systems, the first cathode current collector 120a and/or the second cathode current collector 120b (collectively referred to herein as “cathode current collectors 120”) can include aluminum, or aluminum coated with conductive material that does not electrochemically dissolve at operating potentials of 2.5-5.0V with respect to Li/Li⁺. Such materials include platinum, gold, nickel, conductive metal oxides such as vanadium oxide, and carbon. The first anode current collector 140a and/or the second anode current collector 140b (collectively referred to herein as “anode current collectors 140”) can include copper or other metals that do not form alloys or intermetallic compounds with lithium, carbon, and/or coatings comprising such materials disposed on another conductor.

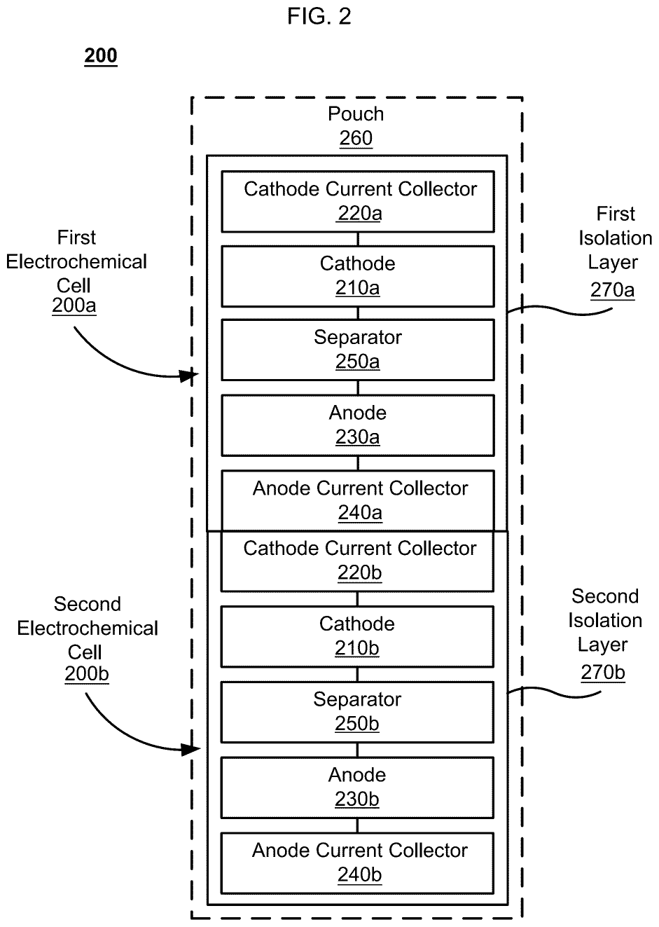

FIG. 2 is a schematic illustration of an electrochemical cell system 200 including a first electrochemical cell 200a and a second electrochemical cell 200b arranged anode-to-cathode in a series configuration, according to an embodiment. Although the electrochemical cell system 200 is arranged anode-to-cathode in the series configuration, i.e., an anode current collector 240a (e.g., a copper current collector) of the first electrochemical cell 200a is electrically coupled to a cathode current collector 220b (e.g., an aluminum current collector) of the second electrochemical cell 200b, this is only for illustrative purposes and a cathode current collector 220a of the first electrochemical 200a may alternatively be electrically coupled to an anode current collector 240b of the second electrochemical cell 200b, to form a single cell. As shown, both the first electrochemical cell 200a and the second electrochemical cell 200b are disposed in a single pouch 260. In some embodiments, the first electrochemical cell 200a and a second electrochemical cell 200b can be electrically coupled in series by direct contact between the respective current collectors (i.e., 240a and 220b, or 220a and 240b) under a compressive force or via welding respective tabs of the current collectors.

In some embodiments, the first electrochemical cell 200a and the second electrochemical cell 200b can be the same or substantially similar to the first electrochemical cell 100a and the second electrochemical cell 100b as described above with reference to FIG. 1. In some embodiments, the first electrochemical cell 200a can have a first chemical composition and the second electrochemical cell 200b can have a second chemical composition, different from the first battery chemistry. For example, the first electrochemical cell 200a may be Li-ion electrochemical cell, and the second electrochemical cell 200b may be a Na-ion or K-ion electrochemical cell. As a consequence, the first electrochemical cell 200a and the second electrochemical cell 200b can have different performance properties from each other. For example, one electrochemical cell can have a high energy density while the second electrochemical cell can have a high power density. In some embodiments, the first electrochemical cell 200a and the second electrochemical cell 200b are fluidically isolated such that the electrolyte of each of the electrochemical cells 200a and 200b is fluidically separated from each other. In some embodiments, a first cathode 210a of the first electrochemical cell 200a may include a first alkali metal such as Li, Na, or K, and a second cathode 210b of the second electrochemical cell 200b may include a second alkali metal such as Li, Na, or K, which is different from the first alkali metal.

In some embodiments, the first cathode 210a may have a first composition such that the first electrochemical cell 200a has a first energy density, and a first power density at a predetermined temperature, and the second cathode 210b has a second composition different from the first composition such that the second electrochemical cell 200b has a second energy density that is less than the first energy density, and a second power density at the predetermined temperature that is greater than the first power density. In some embodiments, the first composition includes Li-ions, and the second composition includes Na-ions or K-ions. In some embodiments, the electrochemical cell system 200 can further include a third electrochemical cell or any number of additional electrochemical cells coupled or connected in series with each other.

In some embodiments, the first electrochemical cell 200a and the second electrochemical cell 200b can be disposed in a single pouch 260. In some embodiments, the electrochemical cell system 200 includes a first isolation layer 270a at least partially enclosing the first electrochemical 210a, and a second isolation layer 270b at least partially enclosing the second electrochemical cell 200b to fluidically isolate the first electrochemical cell 200a from the second electrochemical cell 210b. The first isolation layer 270a and the second isolation layer 270b may allow the first electrochemical cell 200a to include a first electrolyte that is different from a second electrolyte included in the second electrochemical cell 200b, as previously described herein with respect to the electrochemical cell system 100 and keeping the two different electrolytes fluidically isolated from each other. In some implementations, corresponding openings may be provided in the first isolation layer 270a and the second isolation layer 270b through which the anode current collector 240a may be electrically coupled to the cathode current collector 220b in a series configuration. In some embodiments, the electrochemical cell system 200 further includes one or more electrochemical cells electrically connected to the first and the second electrochemical cells 210a and 210b. In some embodiments, the first isolation layer 270a may also be coupled to the second isolation layer 270b (e.g., via heat sealing or adhesives) to secure the first electrochemical cell 200a to the second electrochemical cell 200b.

Coupling the first electrochemical cell 200a in series with the second electrochemical cell 200b may enable constant low current charge or discharge. For example, the first electrochemical cell 200a (e.g., a Li-ion cell) and the second electrochemical cell 200b (e.g., a Na-ion or K-ion cell) may have similar voltage windows and charge/discharge rates. However, the second electrochemical cell 200b having a different chemical composition than the first electrochemical cell 200a may have a lower electronic resistance thus generating less heat than the first electrochemical cell 200a. This may allow the second electrochemical cell 200b to serve as a heat sink for the first electrochemical cell 200a. In some embodiments, coupling the first electrochemical cell 200a in series with the second electrochemical cell 200b may additionally, or alternatively, enable constant or pulse high voltage charge or discharge. For example, the second electrochemical cell 200b, which may have a lower electronic resistance than the first electrochemical cell 200a, may discharge first to satisfy a power or load demand on the system 200. In some such embodiments, the second cathode current collector 220b of the second electrochemical cell 200b (e.g., a Na-ion or K-ion cell) may include aluminum, which can allow for high-power discharge, thus allowing the second electrochemical cell 200b to survive discharge under continuous high-power discharge conditions. Moreover, in some such embodiments, the second anode current collector 240b may include a material (e.g., carbon, disordered carbon, etc.) that can cause the second electrochemical cell 200b to manage or withstand overcharging better than the first electrochemical cell 200a, as well as have high rate charging capability.

The system 200 or any battery system including system 200 can be used in various applications including, but not limited to, electric vehicles, low-speed vehicles, stationary storage systems, electric vertical take-off and landing (eVTOL) aircrafts.

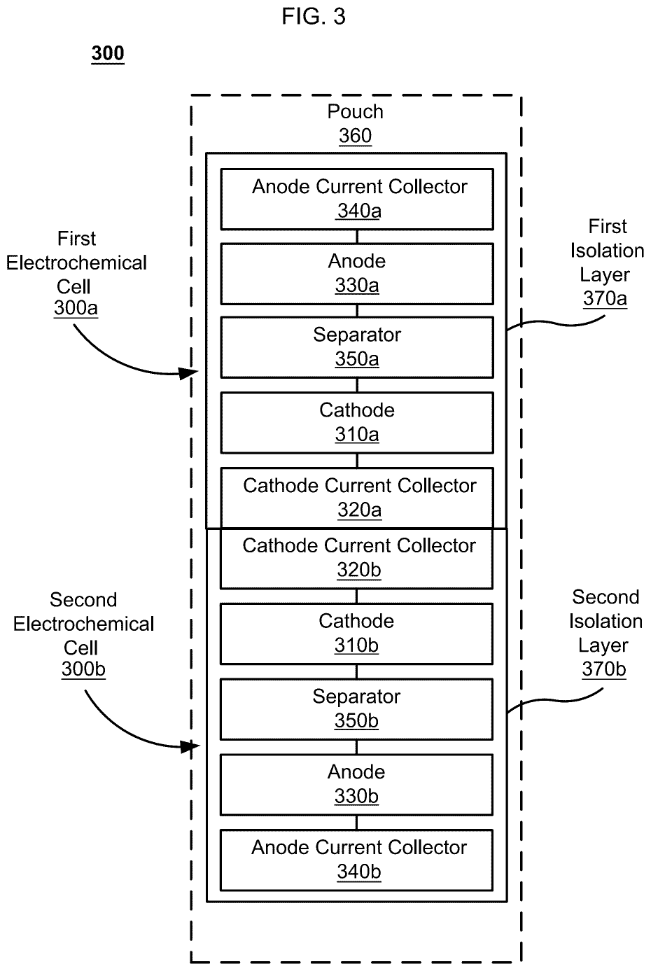

FIG. 3 is a schematic illustration of an electrochemical cell system 300 including a first electrochemical cell 300a and a second electrochemical cell 300b arranged cathode-to-cathode, i.e., a cathode current collector 320a of the first electrochemical cell 300a is electrically coupled to a cathode current collector 320b of the second electrochemical cell 300b in a parallel configuration, according to an embodiment. Although the electrochemical cell system 300 is arranged cathode-to-cathode in the parallel configuration this is only for illustrative purposes and an anode current collector 340a of the first electrochemical cell 300a and an anode current collector 340b of the second electrochemical cell 300b may alternatively be electrically coupled to each other, to form a single cell. In some embodiments, the first electrochemical cell 300a and the second electrochemical cell 300b can be electrically coupled in parallel by direct contact between the respective current collectors (i.e., 320a and 320b, or 340a and 340b) under a compressive force or via welding respective tabs of the current collectors. In some embodiments, the first electrochemical cell 300a and the second electrochemical cell 300b can be the same or substantially similar to the first electrochemical cell 100a and the second electrochemical cell 100b as described above with reference to FIG. 1. Connecting two such cells in parallel can deliver high power density or high energy density on demand, as previously described.

In some embodiments, the first electrochemical cell 300a can have a first chemical composition and the second electrochemical cell 300b can have a second chemical composition, different from the first chemical composition. For example, the first electrochemical cell 300a may be Li-ion electrochemical cell, and the second electrochemical cell 300b may be a Na-ion or K-ion electrochemical cell. As a consequence, the first electrochemical cell 300a and the second electrochemical cell 300b can have different performance properties from each other. For example, one electrochemical cell can have a high energy density while the second electrochemical cell can have a high power density. In some embodiments, the first electrochemical cell 300a and the second electrochemical cell 300b are fluidically isolated such that the electrolyte of each cell is fluidically separated from each other. In some embodiments, the first cathode 310a may include a first alkali metal such as Li, Na, or K, and the second cathode 310b may include a second alkali metal such as Li, Na, or K, which is different from the first alkali metal.

In some embodiments, the first electrochemical cell 300a and the second electrochemical cell 300b can be disposed in a single pouch 360. In some embodiments, the electrochemical cell system 300 includes a first isolation layer 370a at least partially enclosing the first electrochemical 310a, and a second isolation layer 370b at least partially enclosing the second electrochemical cell 300b to fluidically isolate the first electrochemical cell 300a from the second electrochemical cell 310b. The first isolation layer 370a and the second isolation layer 370b may allow the first electrochemical cell 300a to include a first electrolyte that is different from a second electrolyte included in the second electrochemical cell 300b, as previously described herein with respect to the electrochemical cell system 100 and keeping the two different electrolytes fluidically isolated from each other. In some implementations, corresponding openings may be provided in the first isolation layer 370a and the second isolation layer 270b through which the cathode current collector 320a may be electrically coupled to the cathode current collector 320b in a series configuration. In some embodiments, the electrochemical cell system 300 further includes one or more electrochemical cells electrically connected to the first and the second electrochemical cells 310a and 310b. In some embodiments, the first isolation layer 370a may also be coupled to the second isolation layer 370b (e.g., via heat sealing or adhesives) to secure the first electrochemical cell 300a to the second electrochemical cell 300b.

In some embodiments, the second electrochemical cell 300b can have a higher power density than the first electrochemical cell 300a, and the first electrochemical cell 300a can have a higher energy density than the second electrochemical cell 300b. Accordingly, a balance between high energy output and high power delivery can be achieved in the system 300. This might be particularly useful in applications where both bursts of high power and sustained energy delivery are needed. For example, the second electrochemical cell 300b can handle sudden spikes in power demand, such as acceleration in electric vehicles, or high-power devices, while the first electrochemical cell 300a can ensure longer operating times and extended range. In some embodiments, coupling the first electrochemical cell 300a in parallel with the second electrochemical cell 300b may enable constant low current charge or discharge. For example, the first electrochemical cell 300a (e.g., a Li-ion cell) and the second electrochemical cell 300b (e.g., a Na-ion or K-ion cell) may have similar voltage windows and charge/discharge rates. However, the second electrochemical cell 300b having a different chemical composition than the first electrochemical cell 300a may have a lower electronic resistance thus generating less heat than the first electrochemical cell 300a. This may allow the second electrochemical cell 300b to serve as a heat sink for the first electrochemical cell 300a. In some embodiments, coupling the first electrochemical cell 300a in parallel with the second electrochemical cell 300b may additionally, or alternatively, enable constant or pulse high voltage charge or discharge. For example, the majority of the current within system 300 flows through the second electrochemical cell 300b which may have a lower electronic resistance than the first electrochemical cell 300a to reduce cell polarization and drop in power output during discharge and/or prevent dendrite formation during charge. The second electrochemical cell 300b (the lower resistance cell) could also serve as a heat sink to lower operating temperature.

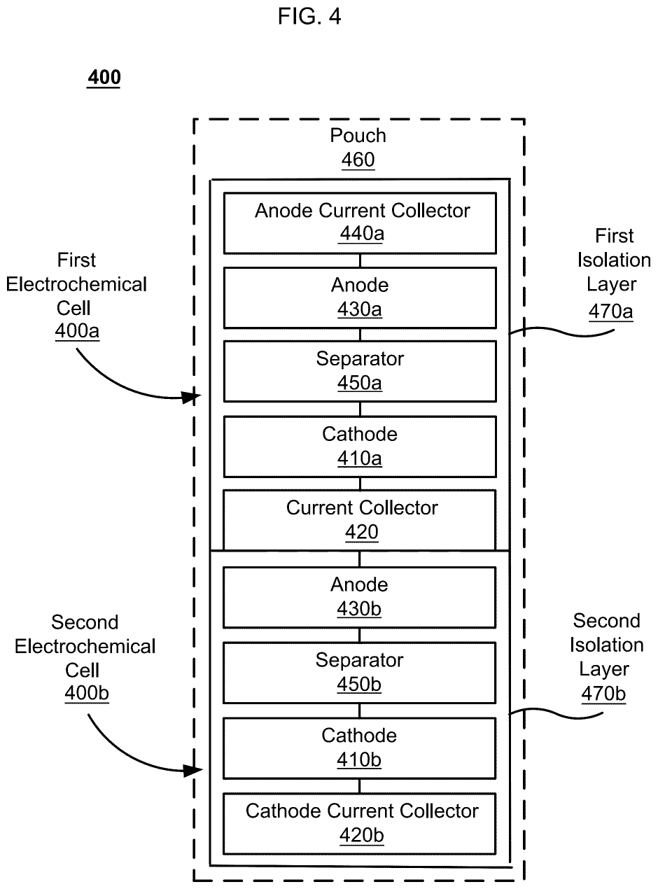

FIG. 4 is a schematic illustration of an electrochemical cell system 400 including a first electrochemical cell 400a and a second electrochemical cell 400b coupled to each other in series with a shared current collector 420, according to an embodiment. Although the electrochemical cell system 400 is arranged cathode-to-anode in the series configuration, i.e., a cathode 410a of the first electrochemical cell 400a is electrically coupled to an anode 430b of the second electrochemical cell 400b, this is only for illustrative purposes and in some implementations, an anode 430a of the first electrochemical cell 400a may alternatively be electrically coupled to a cathode 410b of the second electrochemical cell 400b, to form a single cell. In some embodiments, the first electrochemical cell 400a and the second electrochemical cell 400b can be the same or substantially similar to the first electrochemical cell 100a and the second electrochemical cell 100b as described above with reference to FIG. 1.

As shown in FIG. 4, the first electrochemical cell 400a and the second electrochemical cell 400b can share a common current collector 420. In other words, the cathode 410a and the anode 430b are physically and electronically coupled to the same current collector 420. For example, the cathode 410a may be disposed on a first surface of the current collector 420 and the anode 430b may be disposed on a second surface of the current collector 420 opposite the first surface. Sharing the common current collector 420 can reduce the inactive material weight by excluding a dedicated anode current collector, which can be beneficial for applications that desire low weight materials such as electric vehicles. While FIG. 4 shows the current collector 420 being a cathode current collector included in the first electrochemical cell 400a and being shared by the anode 430b of the second electrochemical cell 400b, in some implementations, the current collector 420 may include an anode current collector included in the second electrochemical cell 400b and being shared by cathode 410a of the first electrochemical cell 400a such that a dedicated cathode current collector is not included in the first electrochemical cell 400a.

In some embodiments, isolation layers 470a and 470b (collectively referred to herein as “isolation layers 470”) may be disposed around the first and second electrochemical cells 400a and 400b, respectively to fluidically isolate the first electrochemical cell 400a from the second electrochemical cell 400b. The isolation layers 470a and 470b may have corresponding openings that allow the use of the shared current collector 420. In other words, in some embodiments, each of the first isolation layer 470a and the second isolation layer 470b define corresponding openings, the first cathode 410a is disposed on a first side of the first cathode current collector, and the second anode 430b is disposed on a second side of the first cathode current collector opposite the first side through the corresponding openings. In some embodiments, the first isolation layer 470a may also be coupled to the second isolation layer 470b (e.g., via heat sealing or adhesives) to secure the first electrochemical cell 400a to the second electrochemical cell 400b.

In some embodiments, the shared current collector 420 may include aluminum. In some embodiments, the shared current collector 420 may be in the form of sheets or mesh, or any combination thereof. In such embodiments, the first anode current collector 440a can include copper, and the first anode current collector 440a can include aluminum. In some embodiments, the shared current collector 420 can be selected to be stable at the operating potentials of the positive and negative electrodes of electrochemical cells 400a and 400b. For example, in non-aqueous lithium systems, the shared current collector 420 can include aluminum, or aluminum coated with conductive material that does not electrochemically dissolve at operating potentials of 2.5-5.0V with respect to Li/Li⁺. Such materials may include, but are not limited to platinum, gold, nickel, conductive metal oxides such as vanadium oxide, and carbon.

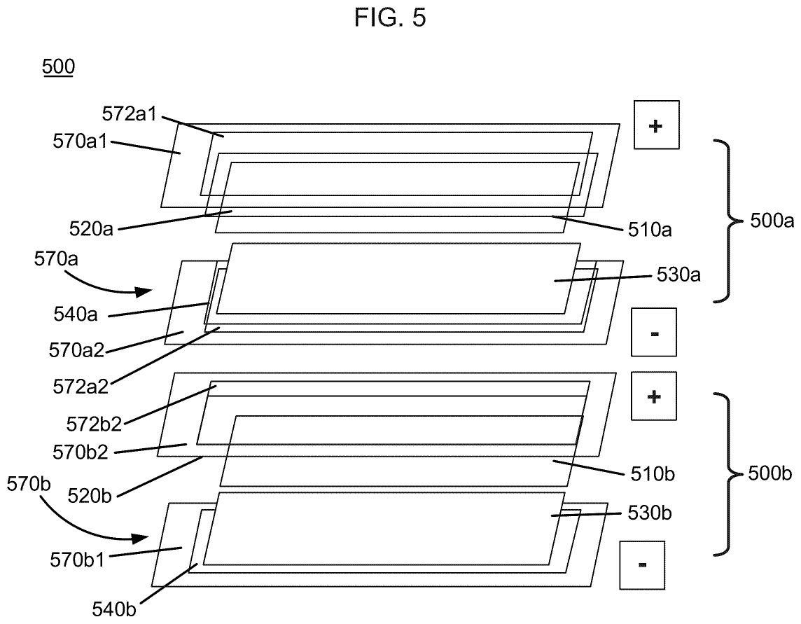

FIG. 5 illustrates an electrochemical cell system 500 including a first electrochemical cell 500a and a second electrochemical cell 500b coupled to each other in series, according to an embodiment. The first electrochemical cell 500a includes a first anode 530a disposed on a first anode current collector 540a, a first cathode 510a disposed on a first cathode current collector 520a, and a first separator (not shown) disposed between the first anode 530a and the first cathode 510a. The second electrochemical cell 500b includes a second anode 530b, a second cathode 510b disposed on a second cathode current collector 520b, and a second separator (not shown) disposed between the second anode 530b and the second cathode 510b.

In some embodiments, the first electrochemical cell 500a includes a battery composition different than the battery composition of the second electrochemical cell 500b. In some embodiments, the composition of the first electrochemical cell 500a (e.g., first cathode 510a and a first electrolyte included in the first cathode 510a) includes lithium-ions, and the composition of the second electrochemical cell 500b includes sodium-ions (e.g., the second cathode 510b and a second electrolyte included in the second cathode 510b). In some embodiments, the first electrochemical cell 500a and the second electrochemical cell 500b can be the same or substantially similar to the first electrochemical cell 100a and the second electrochemical cell 100b as described above with reference to FIG. 1, for example, include similar structure and/or formulation. In some embodiments, the first anode current collector 540a includes copper, and the first cathode current collector 520a, the second cathode current collector 520b, and the second anode current collector 540b include aluminum.

In some embodiments, the system 500 includes a first isolation layer 570a including a first portion 570al and a second portion 570a2 coupled to each other to form a first volume at least partially enclosing the first electrochemical cell 500a. Similarly, the system 500 also includes a second isolation layer 570b including a first portion 570b1 and a second portion 570b2 coupled to each other to form a second volume at least partially enclosing the second electrochemical cell 500b. In some embodiments, the first isolation layer 570a and the second isolation layer 570b may aid in fluidically isolating the first electrochemical cell 500a from the second electrochemical cell 500b. The fluidic isolation of the electrochemical cells 500a and 500b allow different electrolytes to be used with the first electrochemical cell 500a and the second electrochemical cell 500b, which are different in composition from each other. This allows tailoring of electrolytes of each of the electrochemical cells 500a and 500b with respect to their respective battery composition, thereby improving performance of the system 500.

In some embodiments, the second portion 570a2 and second portion 570b2 of the first isolation layer 570a and the second isolation layer 570b, respectively, which face each other may have corresponding openings 572a2 and 572b2, respectively through which the first anode current collector 540a and the second cathode current collector 520b may be physically and electrically coupled to each other, thereby coupling the first electrochemical cell 500a and the second electrochemical cell 500b in series. In some embodiments, the first portions 570al and 570b1 of the first and second isolation layers 570a and 570b, which are located on opposite ends of the system 500 may also have corresponding openings (e.g., 572al of the first portion 570a with the corresponding opening of the first portion 570b1 of the second isolation layer 570b not observable in FIG. 5). In some embodiments, the openings 572al and corresponding opening in the first portion 570b1 of the second isolation layer 570b may allow electrical connections to be made to the first cathode current collector 520a and the second anode current collector 540b. In some embodiments, the first isolation layer 570a may also be coupled to the second isolation layer 570b (e.g., via heat sealing or adhesives) to secure the first electrochemical cell 500a to the second electrochemical cell 500b.

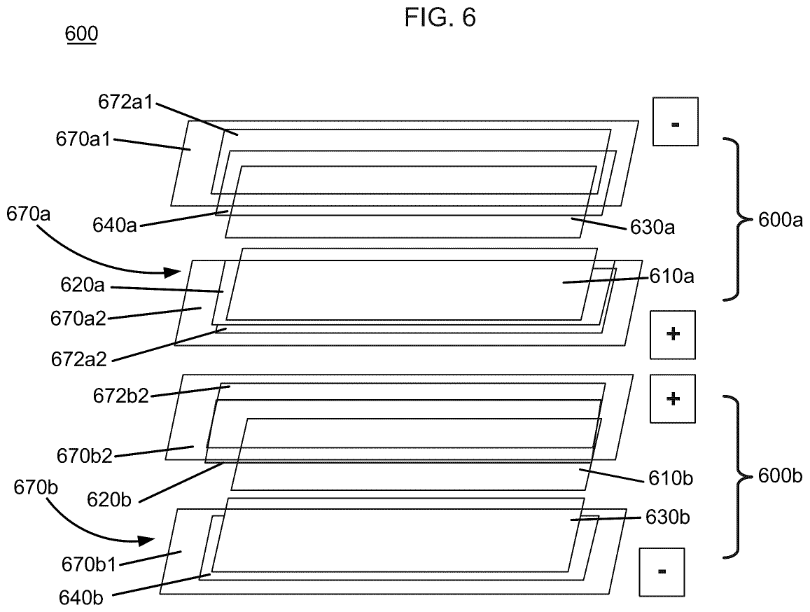

FIG. 6 illustrates an electrochemical cell system 600 including a first electrochemical cell 600a and a second electrochemical cell 600b coupled to each other in parallel, according to an embodiment. The first electrochemical cell 600a includes a first anode 630a disposed on a first anode current collector 640a, a first cathode 610a disposed on a first cathode current collector 620a, and a first separator (not shown) disposed between the first anode 630a and the first cathode 610a. The second electrochemical cell 600b includes a second anode 630b, a second cathode 610b disposed on a second cathode current collector 620b, and a second separator (not shown) disposed between the second anode 630b and the second cathode 610b.

In some embodiments, the first electrochemical cell 600a includes a battery composition different than the battery composition of the second electrochemical cell 600b. In some embodiments, the composition of the first electrochemical cell 600a includes Li-ions, and the composition of the second electrochemical cell 600b includes Na-ions or K-ions. In some embodiments, the first anode current collector 640a includes copper, the first cathode current collector 620a includes aluminum, and the second cathode and anode current collectors 620b and 640b, respectively include aluminum. In some embodiments, the first electrochemical cell 600a and the second electrochemical cell 600b can be the same or substantially similar to the first electrochemical cell 100a and the second electrochemical cell 100b as described above with reference to FIG. 1.

The system 600 includes a first isolation layer 670a includes a first portion 670al and a second portion 670a2 that are coupled to each other to define a first volume at least partially enclosing the first electrochemical cell 600a. Similarly, the system 600 includes a second isolation layer 670b including a first portion 670b1 and a second portion 670b2 that are coupled to each other to define a second volume at least partially enclosing the second electrochemical cell 600b. In some embodiments, the first isolation layer 670a and the second isolation layer 670b may aid in fluidically isolating the first electrochemical cell 600a from the second electrochemical cell 600b. The fluidic isolation of the electrochemical cells 600a and 600b may allow different electrolytes to be used with the first electrochemical cell 600a and the second electrochemical cell 600b that are different in composition from each other, as described with respect to the system 500.

In some embodiments, the second portion 670a2 and second portion 670b2 of the first isolation layer 670a and the second isolation layer 670b, respectively, which face each other may have corresponding openings 672a2 and 672b2, respectively through which the first cathode current collector 620a and the second cathode current collector 620b may be physically and electrically coupled to each other, thereby coupling the first electrochemical cell 600a and the second electrochemical cell 600b in parallel. In some embodiments, the first portions 670al and 670b1 of the first and second isolation layers 670a and 670b, which are located on opposite ends of the system 600 may also have corresponding openings (e.g., 672al of the first portion 670a with the corresponding opening of the first portion 670b1 of the second isolation layer 670b not observable in FIG. 6). In some embodiments, the openings 672al and corresponding opening in the first portion 670b1 of the second isolation layer 670b may allow electrical connections to be made to the first anode current collector 640a and the second anode current collector 640b. In some embodiments, the first isolation layer 670a may also be coupled to the second isolation layer 670b (e.g., via heat sealing or adhesives) to secure the first electrochemical cell 600a to the second electrochemical cell 600b.

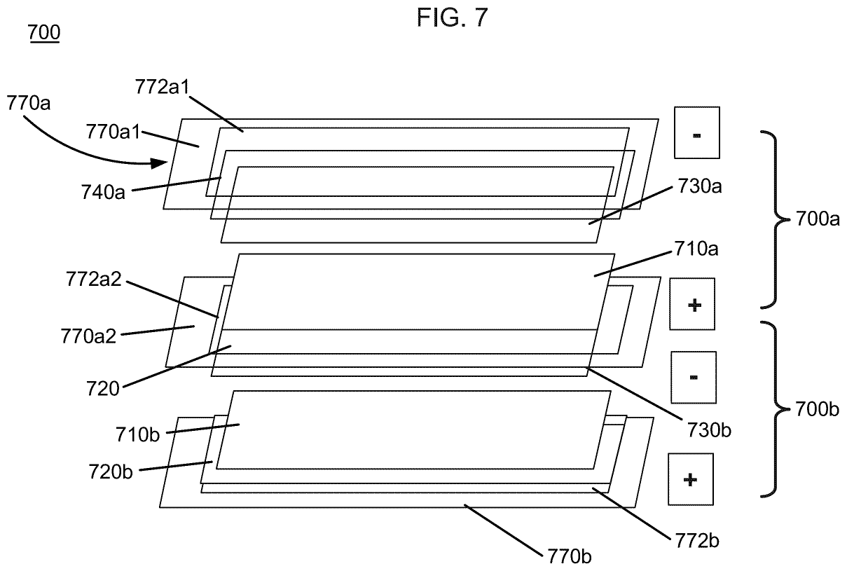

FIG. 7 is a schematic illustration of an electrochemical cell system 700 including a first electrochemical cell 700a and a second electrochemical cell 700b coupled to each other in series with a current collector 720 shared between the electrochemical cells 700a and 700b, according to an embodiment. Sharing a common current collector 720 can reduce the inactive material weight, which is a significant factor for applications desiring low weight materials. The first electrochemical cell 700a includes a first anode 730a disposed on a first anode current collector 740a, a first cathode 710a disposed on a first side of current collector 720, and a first separator (not shown) disposed between the first anode 730a and the first cathode 710a. The second electrochemical cell 700b includes a second anode 730b disposed on a second side of current collector 720 opposite the first side, a second cathode 710b disposed on a second cathode current collector 720b, and a second separator (not shown) disposed between the second anode 730b and the second cathode 710b. In some embodiments, the first side of the current collector 720 is opposite to the second side of the current collector 720. In some embodiments, the first electrochemical cell 700a and the second electrochemical cell 700b can be the same or substantially similar to the first electrochemical cell 100a and the second electrochemical cell 100b as described above with reference to FIG. 1.

In some embodiments, the first electrochemical cell 700a includes a battery composition different than the battery composition of the second electrochemical cell 700b. In some embodiments, the composition of the first electrochemical cell 700a includes Li-ions, and the composition of the second electrochemical cell 700b includes Na-ions or K-ions. In some embodiments, the first anode current collector 740a includes copper, the shared current collector 720 includes aluminum, and the second cathode current collector 720b includes aluminum. In some embodiments, each of the first anode current collector 740a, the shared current collector 720, and the second cathode current collector 720b include aluminum.

The system 700 includes a first isolation layer 770a including a first portion 770al and a second portion 770a2 that are coupled to each other to define a first volume at least partially enclosing the first electrochemical cell 700a. The system 700 includes a second isolation layer 770b that is coupled to the second portion 770a2 of the first isolation layer 770a opposite the first portion 770al to define a second volume at least partially enclosing the second electrochemical cell 700b. In some embodiments, the first isolation layer 770a and the second isolation layer 770b may aid in fluidically isolating the first electrochemical cell 700a from the second electrochemical cell 700b. The fluidic isolation of the electrochemical cells 700a and 700b may allow different electrolytes included in the first electrochemical cell 700a and the second electrochemical cell 700b, which are different in composition from each other to remain fluidically isolated from each other, as previously described herein.

In some embodiments, the second portion 770a2 of the first isolation layer 770a may define an opening 772a2 through which the second anode 730b is disposed on the shared current collector 720, thereby coupling the first electrochemical cell 700a and the second electrochemical cell 700b in series. In some embodiments, the first portion 770al of the first isolation layer 770a and the second isolation layer 770b, which are located on opposite ends of the system 700 may also have corresponding openings 772al and 772b, which may be configured to allow electrical connections to be made to the first anode current collector 740a and the second cathode current collector 720b.

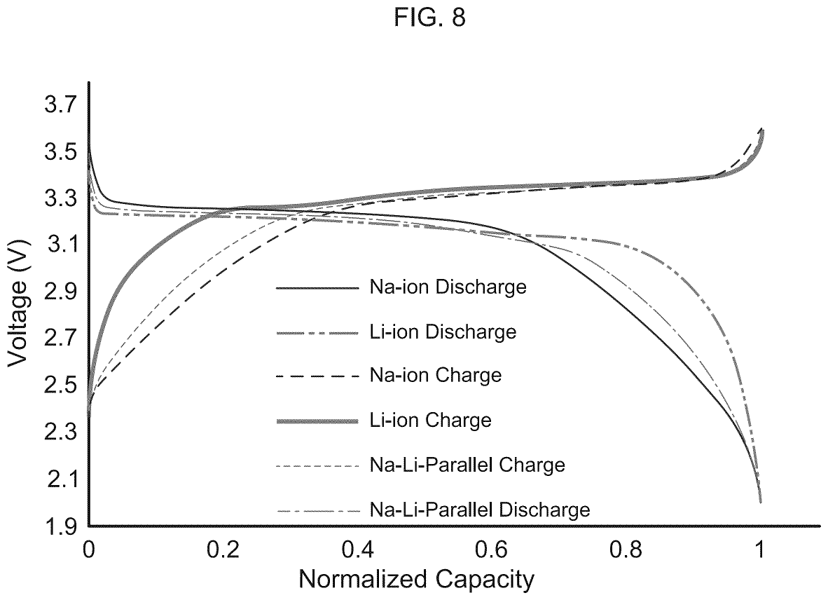

FIG. 8 shows voltage profiles of an electrochemical cell system including a first electrochemical cell having a first composition and a second electrochemical cell having a second composition different from the first composition, coupled to each other in parallel during charge and discharge, as compared to comparative electrochemical cells that has a uniform composition.

The first composition includes Li-ions, and the second composition includes Na-ions, i.e., a sodium ion electrochemical cell and a lithium ion electrochemical cell (Na—Li ion electrochemical cell) are connected to each other in parallel, according to the embodiments described herein. The comparative electrochemical cells used herein are a sodium ion (Na-ion) electrochemical cell and a lithium ion (Li-ion) electrochemical cell having uniform compositions across the respective electrochemical cell. All the electrochemical cells were charged and discharged using a constant current at C/3 rate. The charge/discharge curve corresponding to the Na—Li ion electrochemical cell enables a good correlation between state of charge (SOC) and cell voltage.

FIG. 8 demonstrates the feasibility and advantages of connecting Na-ion and Li-ion cells in parallel, according to the embodiments described herein. The voltage profile of the parallel cell resembles the superimposition of the individual Li-ion and Na-ion cells, indicating a successful integration. Moreover, the Na—Li ion electrochemical parallel cell offers two significant advantages: (1) easier state-of-charge (SOC) estimation by a battery management system due to the sloped profile of the Na—Li ion electrochemical cell as opposed to a flat plateau; and (2) more consistent power output ensured by the sloped profile at lower SOC. Further, the steepness of the discharge curve of the comparative Li-ion electrochemical cell indicates a more pronounced voltage drop as the battery discharges, which might be undesirable in applications where consistent voltage output over time is desired. In addition, the Na—Li ion electrochemical cell have a better charging and discharging rates compared to Na-ion electrochemical cell. This implies that the Na—Li electrochemical cell can be charged and discharged more quickly relative to the Li-ion and Na-ion cells, which is important for applications with high power demands. These findings underscore the potential of the electrochemical cells described herein in enhancing battery performance and management.

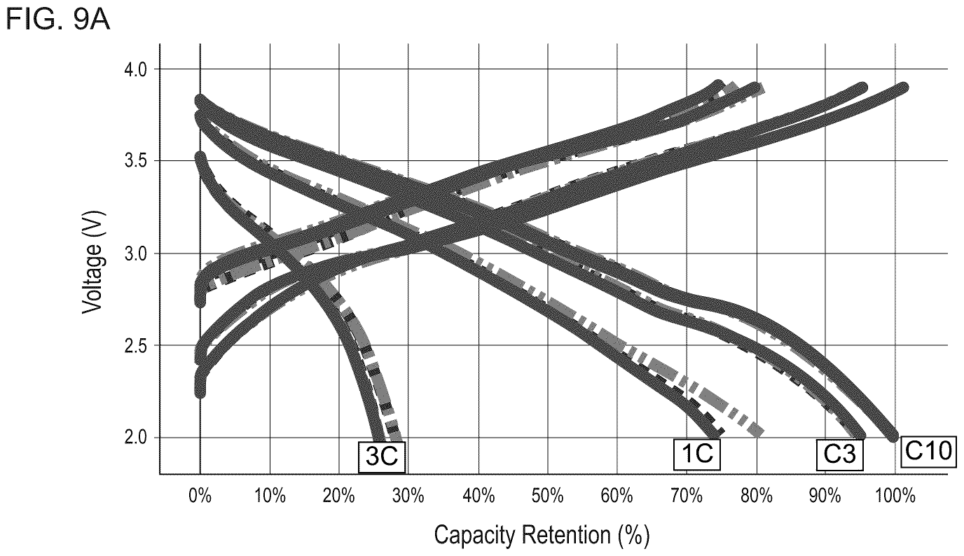

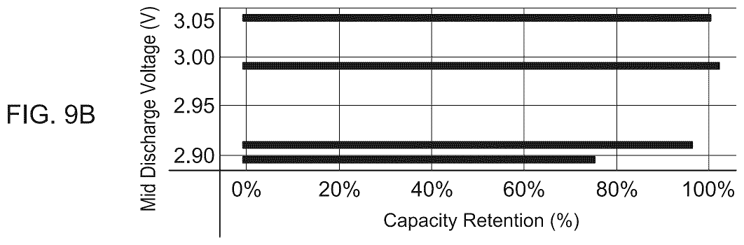

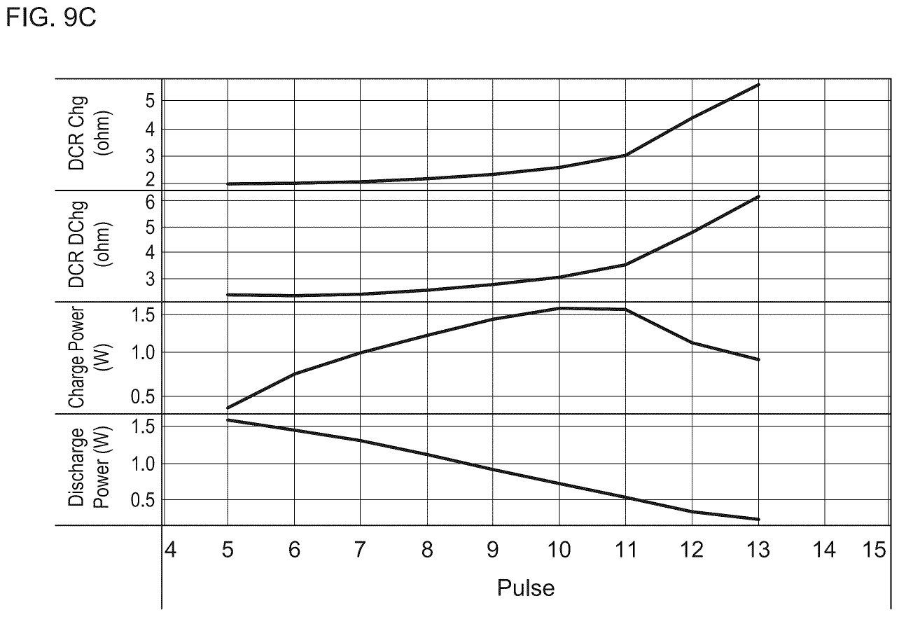

FIG. 9A presents voltage versus capacity retention plots for a comparative Na-ion electrochemical cell at various charge/discharge rates at 25° C. These plots demonstrate the effect of different charging/discharging rates (i.e., 3C, 1C, C/3, and C/10) on the capacity retention of the cell. The Na-ion cell, which has a uniform composition, includes a carbon anode, a sodium-ion oxide cathode, and a polyethylene separator. The comparative Na-ion electrochemical cell has an areal capacity of about 5.5 mAh/cm² and uses NaPF₆ carbonate electrolyte. The capacity retention for each cycle is calculated by normalizing the discharge capacity to that of the formation cycle. The term ‘C-rate’ refers to the ratio of the current to the battery's nominal capacity. For instance, a 1C rate implies that the battery is charged or discharged at a current equal to its nominal capacity. A higher C-rate (e.g., 3C) indicates a faster charge or discharge process. The results from the analysis are summarized in Table 1 and illustrated in FIG. 9A. The results revealed that the capacity retention of the Na-ion cell decreased as the charge/discharge rate increased. Notably, the capacity retention percentage at a 3C rate was significantly lower compared to those at lower discharge rates. Rate performance of an electrochemical cell is an indication of its ability to deliver and receive electrical energy at different rates of charge and discharge while maintaining satisfactory performance. A cell with good rate performance will typically maintain a significant portion of its nominal capacity even at high C-rates.

FIG. 9B shows plots of mid-discharge voltages versus capacity retention percentage at different discharging current rates. The mid-discharge voltage is measured when the battery has discharged 50% of its total energy. A flat curve indicates that the battery maintains a consistent voltage as it discharges, which is desirable. That is, the comparative Na-ion cell used in this example discharges properly at different discharging rates.

TABLE 1
Change in capacity retention (%) of Na-ion electrochemical
cell with respect to C-rates.

| C-Rate | Retention (%) |
|---|---|
| C/10 | 100 |
| C/3 | 95 |
| 1C | 75-81 |
| 3C | 25-28 |

FIG. 9C shows plots of charge/discharge direct current resistance (DCR Chg/DChg), and charge/discharge power vs. number of pulses. A pulse refers to a sudden, short-duration surge in current that a battery may experience. The plots demonstrate the cell's power output changes in response to increasing pulse numbers. The State of Charge (SOC) of the Na-ion electrochemical cell at the point of peak charge and discharge was observed to be 40-50% and 100%, respectively. SOC represents the current charge level of the battery as a percentage of its total capacity, where 0% SOC typically indicates a fully discharged battery, and 100% SOC indicates a fully charged battery. The SOC at which a battery achieves its peak charge or discharge power can indicate the battery's optimal operating range for delivering high power. This is often referred to as the “sweet spot” for power delivery. Knowing this SOC point is valuable for applications that require bursts of high power, such as electric vehicles during acceleration or regenerative braking.

The DCIR vs. pulse curve presented in FIG. 9C provides valuable information about how a battery's internal resistance affects its performance when subjected to pulse loads at different states of charge (SOC). As shown in FIG. 9C, DCIR tends to increase during both charge and discharge cycles in response to increasing pulses, due to factors such as elevated temperature, changes in ion mobility as the State of Charge (SOC) fluctuates, chemical alterations within the battery electrodes, aging effects over time, and the generation of additional heat and stress caused by high current flow etc. Table 2 lists DCIR charge/discharge values obtained from FIG. 9C at 10% and 100% SOC. High DCIR, which typically corresponds to elevated internal resistance, can result in energy losses as heat during charge and discharge. Consequently, the SOC at which the DCIR is measured can help assess the battery's efficiency, as a high DCIR at lower SOC levels might suggest reduced power output efficiency. Furthermore, considering that a high DCIR can lead to an increase in temperature, it is crucial to approach this issue with safety in mind. Extremely high DCIR levels may pose significant safety risks.

TABLE 2
Direct current resistance (DCIR) charge/discharge
values with respect to SOC.

| | DCIR | DCIR |
|---|---|---|
| SOC (%) | Charge (ohm) | Discharge (ohm) |
| 10 | 5.57 | 6.15 |
| 100 | 1.94 | 2.34 |

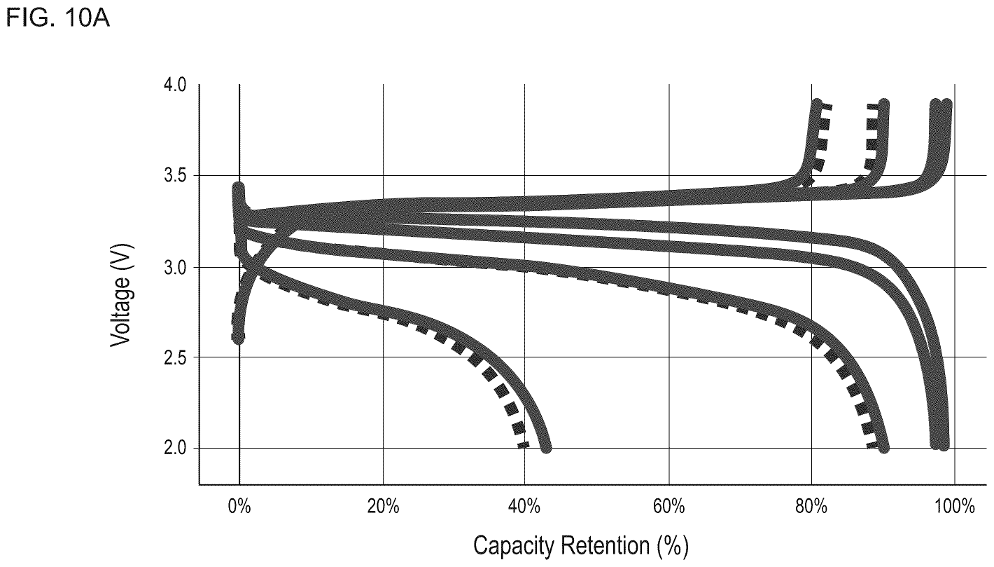

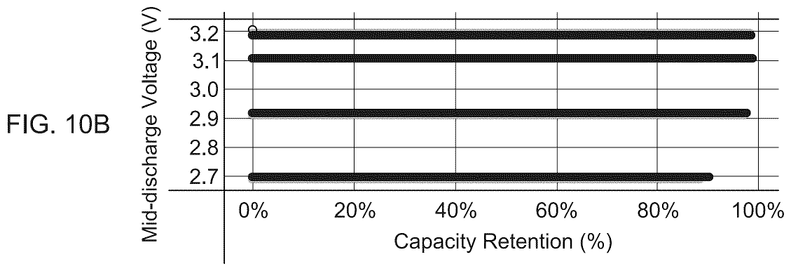

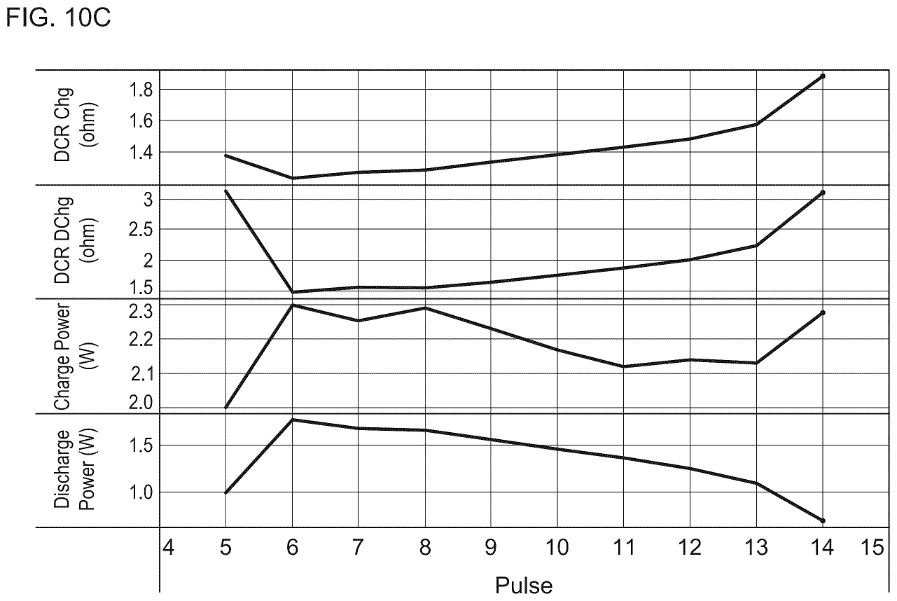

FIG. 10A illustrates the voltage versus capacity retention for a comparative Li-ion electrochemical cell at various charge/discharge rates at 25° C. This graph highlights the impact of different charging/discharging rates on the cell's capacity retention. The Li-ion electrochemical cell used in this experiment included a graphite anode, a LFP cathode with sodium, and a polyethylene separator between the anode and cathode. This cell also contained a NaPF₆ carbonate electrolyte. The Na-ion electrochemical cell demonstrated an areal capacity of approximately 6.5 mAh/cm². The analysis, summarized in Table 3 and depicted in FIG. 10A, indicates that the Li-ion cell's capacity retention decreases as the charge/discharge rate increases. It's noteworthy that the capacity retention percentage at a 3C rate was significantly lower compared to lower discharge rates.

FIG. 10B illustrates the relationship between mid-discharge voltages at various discharge current rates and the percentage of capacity retention. The mid-discharge voltage is defined as the voltage measured when half of the battery's total energy has been discharged. A flat curve is indicative of a battery that maintains a consistent voltage during discharge, which is an ideal characteristic. This suggests that the Li-ion cell according to the embodiments described herein discharge efficiently across different discharge rates.

TABLE 3
Change in capacity retention (%) of Li-ion electrochemical
cell with respect to C-rates.

| C-Rate | Retention (%) |
|---|---|
| C/10 | 100 |
| C/3 | 98 |
| 1C | 89-90 |
| 3C | 40-43 |

FIG. 10C shows plots of charge/discharge direct current resistance (DCR Chg/DChg), and charge/discharge power vs. number of pulses. The State of Charge (SOC) of a battery at the point of peak charge or discharge was found to be 70-90% and 90%, respectively. As shown in FIG. 10C, DCIR tends to increase (after the sixth pulse) during both charge and discharge processes in response to pulse numbers. Table 4 summarizes DCIR charge/discharge values derived from FIG. 10C at certain level of SOC (i.e., at 10% and 100% SOC).

TABLE 4
Direct current resistance (DCIR) charge/discharge
values with respect to SOC.

| | DCIR | DCIR |
|---|---|---|
| SOC (%) | Charge (ohm) | Discharge (ohm) |
| 10 | 1.88 | 3.08 |
| 100 | 1.37 | 3.11 |

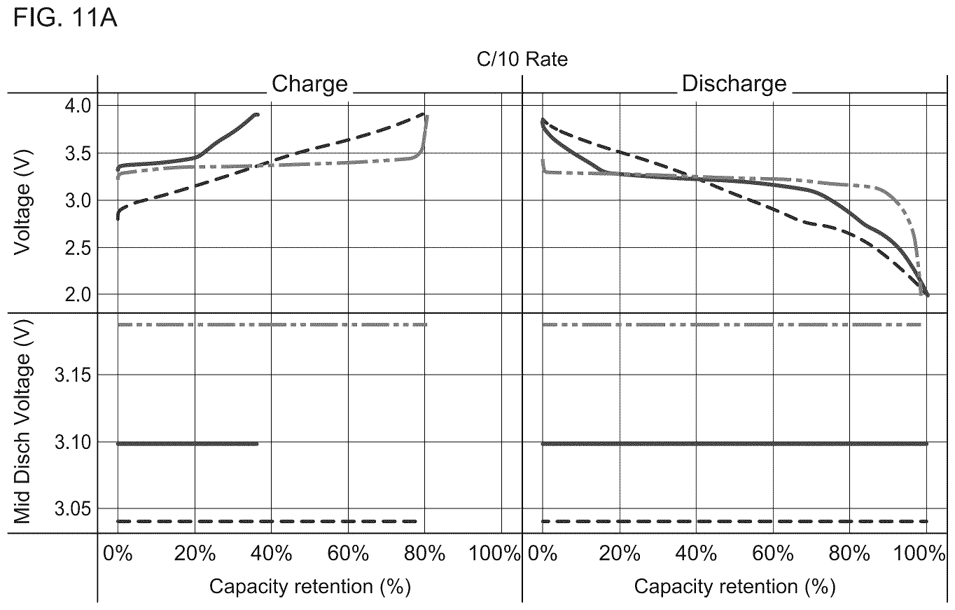

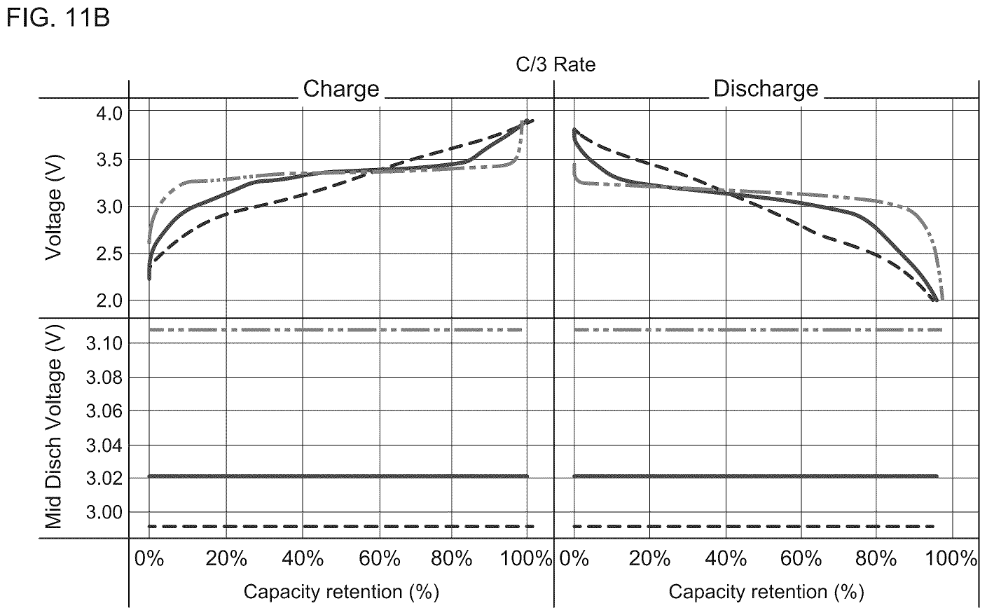

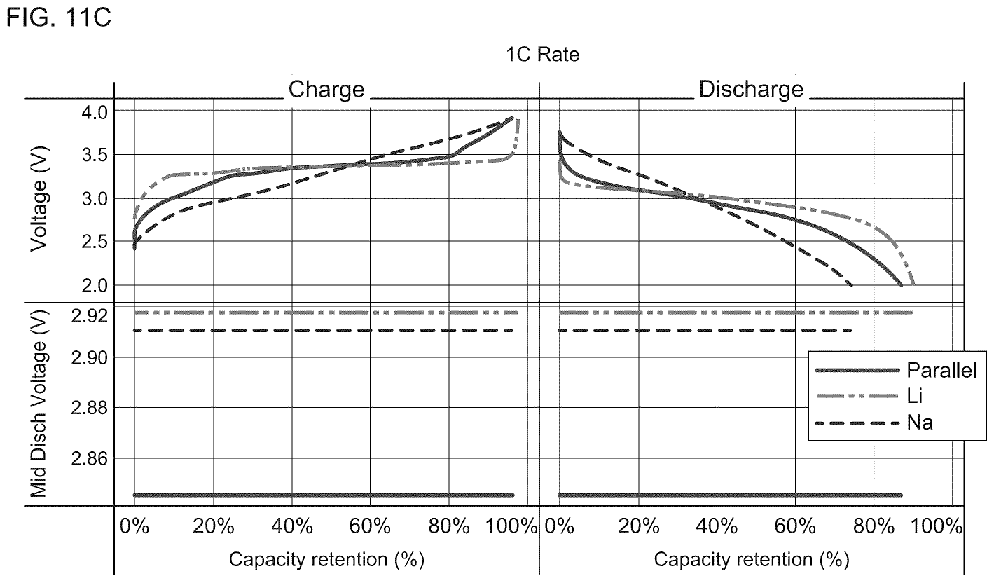

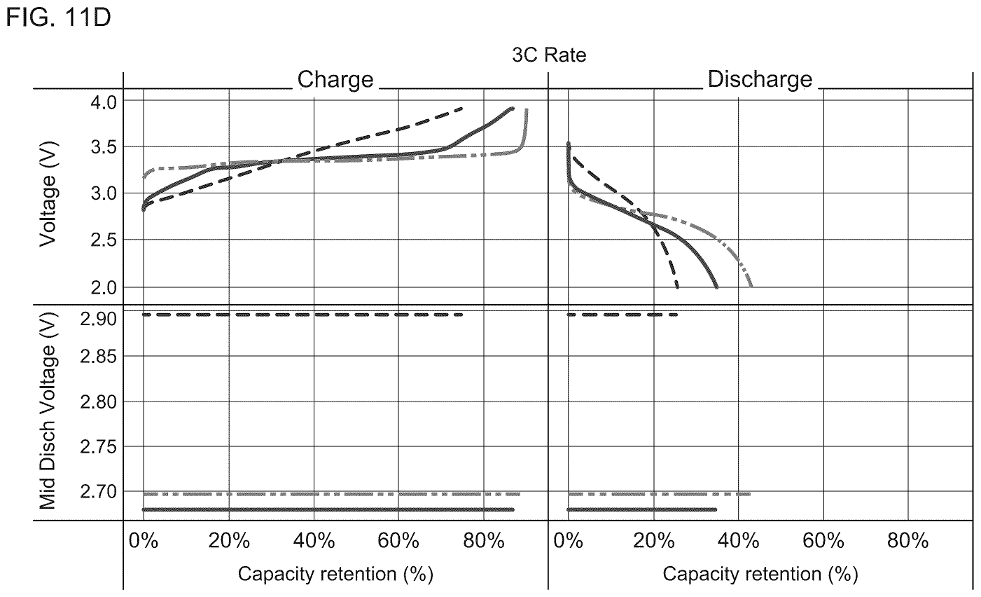

FIGS. 11A-11D compare power performance of the comparative Na-ion electrochemical cell and the Li-ion electrochemical cell having uniform compositions with an electrochemical cell system including Na-ion cell and Li-ion cell connected to each other in parallel (also referred to herein as “Na—Li ion cell”) at different charge/discharge rates (i.e., C/10, C/3,1C and 3C, respectively) at 25° C. The Na—Li ion cell has a cell capacity of about 160 mAh. As depicted in FIG. 11A, the voltage profile of the parallel Na—Li ion cell, at a charge/discharge rate of C/10, mirrors the superimposed profiles of individual Li-ion and Na-ion cells, signifying successful integration. The voltage charge/discharge profile of this parallel Na—Li ion cell bears resemblance to the Li-ion cell between a 20% and 70% state of charge (SOC), and to the Na-ion cell between 10% and 20% SOC as well as between 70% and 100% SOC. The unique slope characteristics of the parallel Na—Li ion cell could prove advantageous for state of charge (SOC) monitoring, as it facilitates a strong correlation between SOC and cell voltage.

Table 5, which summarizes the results derived from FIGS. 11A-11D, provides a comparative analysis of the capacity retention percentages of Li-ion, Na-ion, and Na—Li-ion electrochemical cells in relation to varying discharge current rates (3C, 1C, C/3, and C/10). The data reveals that the current Li-ion cells demonstrate lower resistance and superior rate performance, attributable to optimized electrolyte and cathode composition. Data presented in Table 5 serves as a model for linking two cells with varying performance characteristics. By connecting Li-ion and Na-ion cells in parallel, the advantages of both types of cells can be combined. To illustrate, when compared to the lower power cell, such as Na-ion cell in this example, a parallel configuration offers benefits in terms of (SOC) monitoring and enhanced rate performance.

TABLE 5
Change in capacity retention (%) of Li-ion, Na-ion, and
Na-Li-ion electrochemical cells with respect to C-rates.

| | Na-Li-ion Cell | Na-ion Cell | Li-ion Cell |
|---|---|---|---|
| C-Rate | Retention (%) | Retention (%) | Retention (%) |
| C/10 | 100 | 100 | 100 |
| C/3 | 96 | 95 | 98 |
| 10 | 87 | 75-81 | 89-90 |
| 3C | 35 | 25-28 | 40-43 |

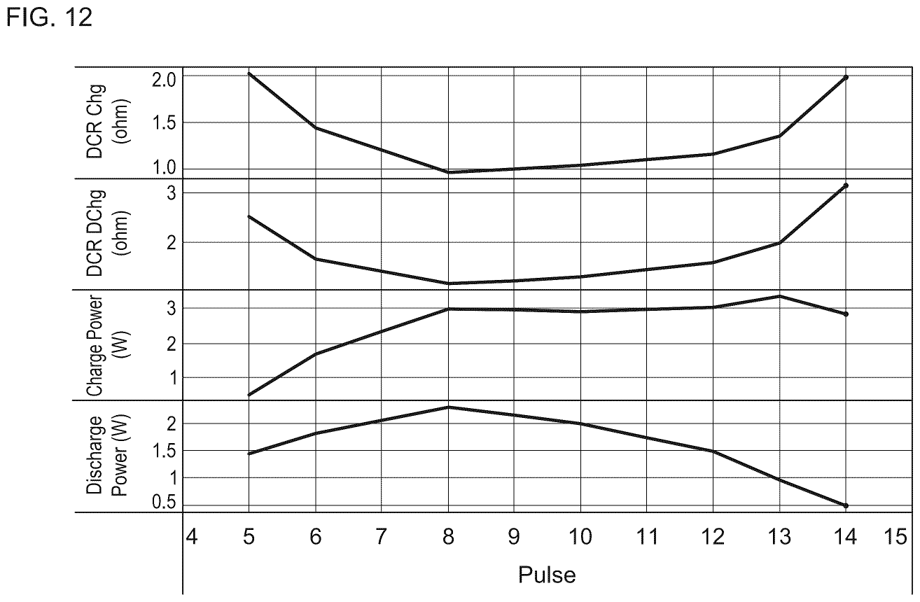

FIG. 12 shows plots of charge/discharge direct current resistance (DCR Chg/DChg), and charge/discharge power vs. number of pulses for Na—Li ion electrochemical cell at 3C. The State of Charge (SOC) of a battery at the point of peak charge or discharge was found to be 20-70% and 70%, respectively. As shown in FIG. 12, DCIR tends to increase after the eighth pulse during both charge and discharge processes. Our findings, summarized in Table 6, compares DCIR charge/discharge values for Na-ion, Li-ion and Na—Li ion cells at certain levels of SOC (i.e., at 10% and 100% SOC).

TABLE 6
Change in capacity retention (%) of Na-ion electrochemical
cell with respect to C-rates.

| SOC | Li-ion DCIR | Na-ion DCIR | Na-Li-ion DCIR |
|---|---|---|---|
| (%) | Chg/Dischg (ohm) | Chg/Dischg (ohm) | Chg/Dischg (ohm) |
| 10 | 1.88/3.08 | 5.57/6.15 | 1.98/3.17 |
| 100 | 1.37/3.11 | 1.94/2.34 | 2.02/2.51 |

Table 7 enumerates the charge states of Li-ion, Na-ion, and Na—Li-ion electrochemical cells at their peak charge or discharge points. The current Na-ion cell, despite having a higher resistance than the Li cell, demonstrates the potential of parallel connection with cells of varying resistances. This configuration enhances the charging capability by sustaining high pulse charge power over an extended State of Charge (SOC) window.

TABLE 7
Change in capacity retention (%) of Na-ion electrochemical
cell with respect to C-rates.

| | Peak Charge | Peak Discharge |
|---|---|---|
| Cell Chemistry | Power SOC | Power SOC |
| Na-ion | 40-50% | 100% |
| Li-ion | 70-90% | 90% |
| Parallel | 20-70% | 70% |

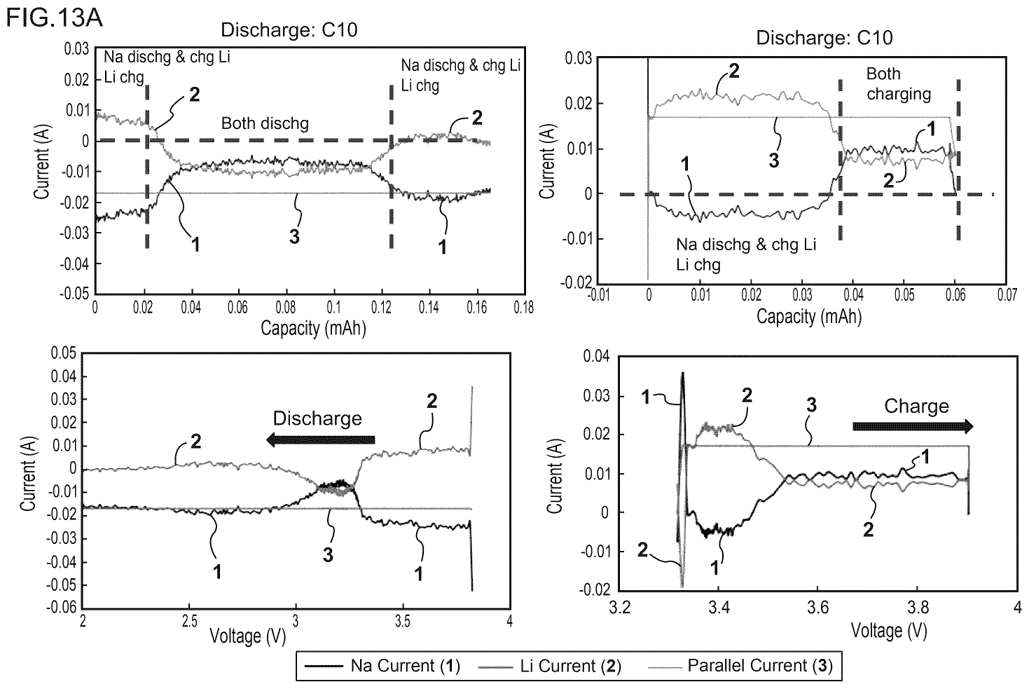

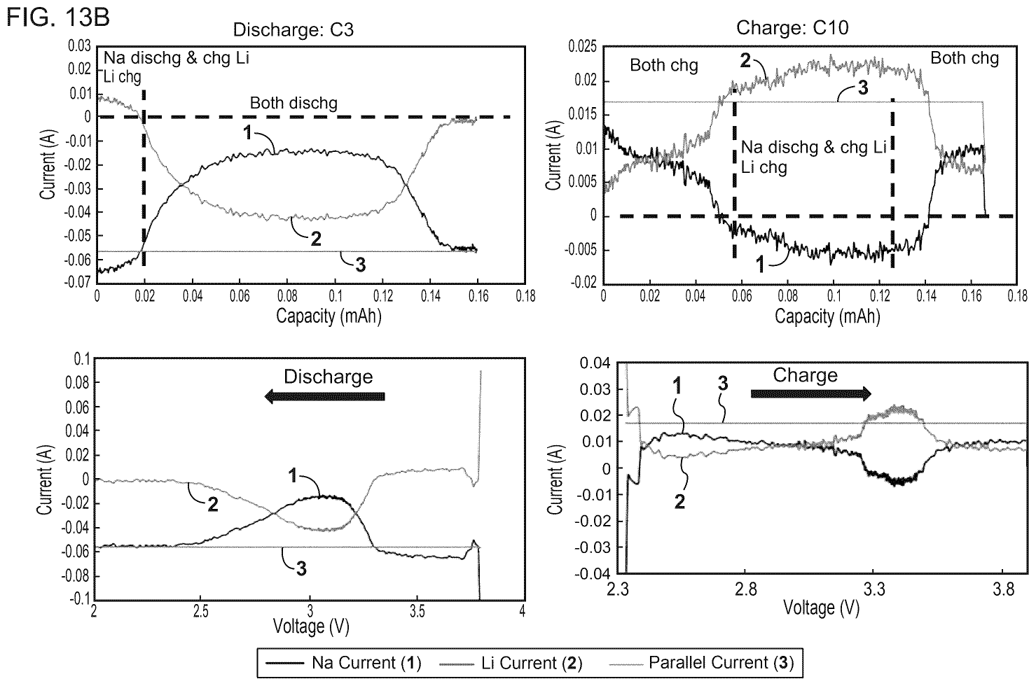

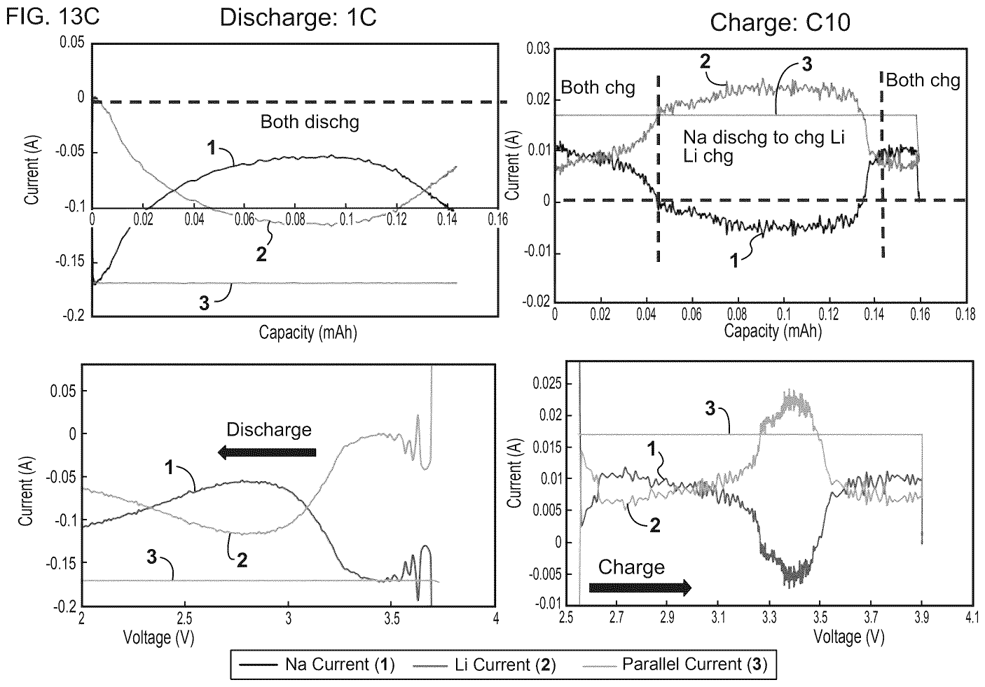

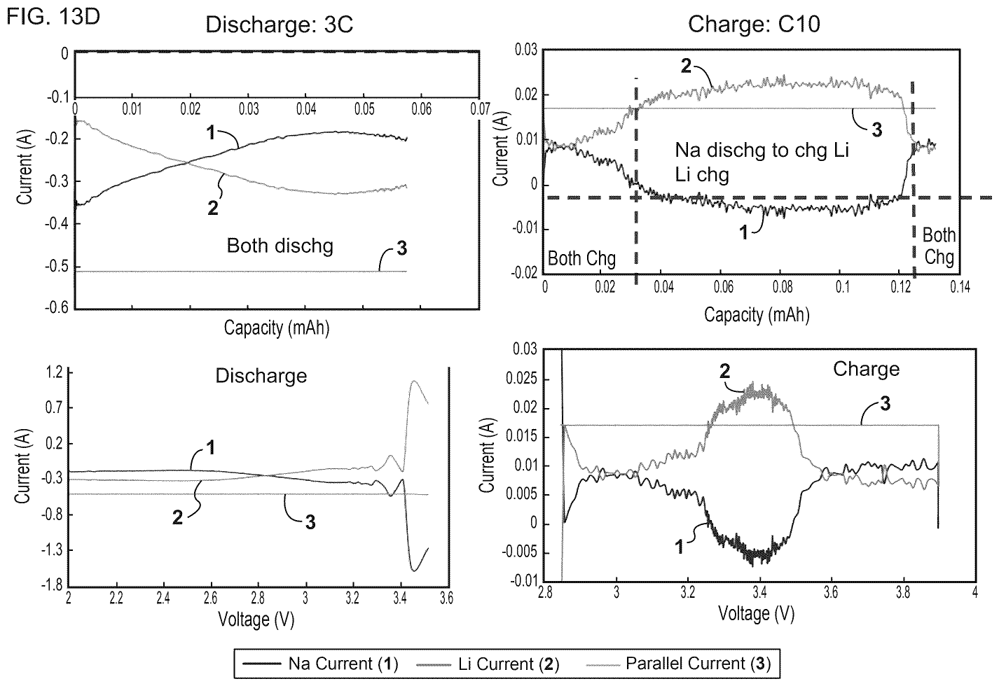

FIGS. 13A-13D illustrate the current profiles of the comparative Na-ion electrochemical cell, the comparative Li-ion electrochemical cell, and the Na—Li ion electrochemical cell at various charge/discharge rates (specifically, C/10, C/3, and 1C) at a temperature of 25° C., in relation to both capacity retention (mAh) and voltage (voltage). When examining current versus voltage and current versus capacity curves for batteries or energy storage devices, a current level that falls below zero is typically indicative of a discharge phase (shown as “dischg” in FIGS. 13A-13D). On the other hand, a current level above zero typically indicates a charging phase (“shown as “chg” in FIGS. 13A-13D). For all discharge rates, Na-ion cell is found to play a crucial role in the discharge process at low states of charge (SOC). Na-ion cell also exhibits a higher charging current at high SOC. Furthermore, Na-ion cell was found responsible for the final charge, which could potentially help in mitigating plating issues in Li-ion cells when Na—Li ion is couple to each other.

The exemplary observations illustrated herein demonstrate that electrochemical systems including Na-ion cell and Li-ion cell connected to each other offer several advantages including, for example, maintaining high pulse power capability within a broader State of Charge (SOC) window, reducing the risk of metal plating at high SOC, providing balanced rate performance, and having a voltage profile that may enable more accurate SOC monitoring.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified, and such modification are in accordance with the variations of the invention. Additionally, certain of the steps may be performed concurrently in a parallel process, when possible, as well as performed sequentially as described above. The embodiments have been particularly shown and described, but it will be understood that various changes in form and details may be made.

The invention claimed is:

1. An electrochemical cell system, comprising;
a first electrochemical cell, comprising: a first anode current collector, a first anode disposed on the first anode current collector, a first cathode current collector, a first cathode disposed on the first cathode current collector, and a first separator disposed between the first anode and the first cathode, the first cathode having a first composition such that the first electrochemical cell has a first energy density, and a first power density at a predetermined temperature;
a second electrochemical cell, comprising: a second anode, a second cathode current collector, a second cathode disposed on the second cathode current collector, and a second separator disposed between the second anode and the second cathode, the second cathode having a second composition different from the first composition such that the second electrochemical cell has a second energy density that is less than the first energy density, and a second power density at the predetermined temperature that is greater than the first power density.

2. The electrochemical cell system of claim 1, wherein the first composition includes lithium-ions, and the second composition includes sodium-ions.

3. The electrochemical cell system of claim 2, further comprising:
a second anode current collector, the second anode being disposed on the second anode current collector,
wherein the first anode current collector includes copper and the second anode current collector includes aluminum.

4. The electrochemical cell system of claim 1, wherein the first electrochemical cell is coupled to the second electrochemical cell in parallel.

5. The electrochemical cell system of claim 1, wherein the first electrochemical cell is coupled to the second electrochemical cell in series.

6. The electrochemical cell system of claim 5, wherein the first cathode is disposed on a first side of the first cathode current collector, and the second anode is disposed on a second side of the first cathode current collector opposite the first side.

7. The electrochemical cell system of claim 6, wherein the first anode current collector includes copper, the first cathode current collector includes aluminum, and the second cathode current collector includes aluminum.

8. The electrochemical cell system of claim 6, wherein each of the first anode current collector, the first cathode current collector, and the second cathode current collector includes aluminum.

9. The electrochemical cell system of claim 1, wherein the first energy density is at least 10% greater than the second energy density.

10. The electrochemical cell system of claim 1, wherein the second power density is at least 30% greater than the first power density at the predetermined temperature.

11. The electrochemical cell system of claim 1, wherein:
the first electrochemical cell has a first fast charge current limit at a predetermined temperature, and
the second electrochemical cell has a second fast charge current limit at the predetermined temperature, the second fast charge current limit greater than the first fast charge current limit.

12. The electrochemical cell system of claim 1, wherein:
the first electrochemical cell is configured such that discharging of the first electrochemical cell below 1.5V or over-discharging of the first electrochemical cell causes degradation in performance of the first electrochemical cell, and
the second electrochemical cell is configured such that discharging of the second electrochemical cell below 1.5V or over-discharging of the second electrochemical cell does not cause performance degradation of the second electrochemical cell.

13. An electrochemical cell system, comprising;
a first electrochemical cell, comprising: a first anode current collector, a first anode disposed on the first anode current collector, a first cathode current collector, a first cathode disposed on the first cathode current collector, a first separator disposed between the first anode and the first cathode, and a first electrolyte in contact with at least the first anode and the first cathode; and
a second electrochemical cell, comprising: a second anode, a second cathode current collector, a second cathode disposed on the second cathode current collector, a second separator disposed between the second anode and the second cathode, and a second electrolyte in contact with at least the second anode and the second cathode, the second electrolyte being different from the first electrolyte,
wherein the first electrochemical cell is fluidically isolated from the second electrochemical cell such that the first electrolyte is fluidically isolated from the second electrolyte.

14. The electrochemical cell system of claim 13, wherein the first electrolyte includes a first metal-ion, and the second electrolyte includes a second metal-ion during a discharge or charge cycle of the electrochemical cell system, the first metal-ion and the second metal-ion including one of lithium-ion, sodium-ion, potassium-ion, magnesium-ion, calcium-ion, zinc-ion, or aluminum-ion, the first metal-ion being different from the second metal-ion.

15. The electrochemical cell system of claim 13, further comprising:
a first isolation layer at least partially enclosing the first electrochemical, and
a second isolation layer at least partially enclosing the second electrochemical cell to fluidically isolate the first electrochemical cell from the second electrochemical cell.

16. The electrochemical cell system of claim 15, wherein:
the first anode current collector is electrically coupled to the second cathode current collector such that the first electrochemical cell is coupled to the second electrochemical cell in series, and
each of the first isolation layer and the second isolation layer define corresponding openings, the first anode current collector electrically coupled to the second cathode current collector through the corresponding openings.

17. The electrochemical cell system of claim 15, wherein:
the first cathode current collector is electrically coupled to the second cathode current collector such that the first electrochemical cell is coupled to the second electrochemical cell in parallel, and
each of the first isolation layer and the second isolation layer define corresponding openings, the first cathode current collector electrically coupled to the second cathode current collector through the corresponding openings.

18. The electrochemical cell system of claim 15, wherein:
each of the first isolation layer and the second isolation layer define corresponding openings,
wherein the first cathode is disposed on a first side of the first cathode current collector, and the second anode is disposed on a second side of the first cathode current collector opposite the first side through the corresponding openings.

19. The electrochemical cell system of claim 13, wherein:
the first electrochemical cell has a first fast charge current limit at a predetermined temperature, and
the second electrochemical cell has a second fast charge current limit at the predetermined temperature, the second fast charge current limit greater than the first fast charge current limit.

20. The electrochemical cell system of claim 13, wherein:
the first electrochemical cell is configured such that discharging of the first electrochemical cell below 1.5V or over-discharging of the first electrochemical cell causes degradation in performance of the first electrochemical cell, and
the second electrochemical cell is configured such that discharging of the second electrochemical cell below 1.5V or over-discharging of the second electrochemical cell does not cause performance degradation of the second electrochemical cell.
